(19) United States
(12) Patent Application Publication
(10) Pub. No.: US 2026/0012928 A1
(43) Pub. Date: Jan. 8, 2026

(54) CHANNEL-CONDITION-BASED CONFIGURED GRANT CONFIGURATION

(71) Applicant: QUALCOMM Incorporated, San Diego, CA (US)

(72) Inventors: Shay LANDIS, Hod Hasharon (IL); Ran BERLINER, Kfar-Aviv (IL); Amit BAR-OR TILLINGER, Tel-Aviv (IL); Konstantin KUPERSHLAK, Ramat Gan (IL)

(21) Appl. No.: 18/765,391

(22) Filed: Jul. 8, 2024

(51) Int. Cl. H04W 72/02; H04W 72/0446; H04W 72/0453

(52) U.S. Cl. CPC H04W 72/02; H04W 72/0446; H04W 72/0453

(57) ABSTRACT

Various aspects of the present disclosure generally relate to wireless communication. Some aspects relate to channel-condition-based (or channel aware) dedicated grant-free transmission configurations. Some aspects more specifically relate to a configured grant (CG) configuration that is associated with one or more parameters that are selectable (for example, by a user equipment (UE)) in accordance with current channel conditions experienced by the UE. In some aspects, the CG configuration may be associated with one or more rules that can be used to define or otherwise indicate values of one or more parameters for the CG configuration. The UE may transmit one or more communications, via a transmission occasion configured via the CG configuration, in accordance with the one or more values of respective parameters for the CG configuration.

### FIELD OF THE DISCLOSURE

Aspects of the present disclosure generally relate to wireless communication and specifically relate to techniques, apparatuses, and methods associated with a channel-condition-based configured grant configuration.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IOT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

In some examples, a wireless communication device (for example, a user equipment (UE) or a network node) may transmit one or more communications using a grant-free transmission occasion (for example, a transmission occasion that is not associated with an explicit grant). For example, a UE may transmit one or more communications in accordance with a configured grant (CG) configuration. A network node may transmit one or more communications in accordance with a semi-persistent scheduling (SPS) configuration. A grant-free transmission occasion may include periodic radio resources that are configured as available for use by the wireless communication device, such that a network node does not need to transmit separate control information communications (for example, downlink control information communications) to schedule each communication by the wireless communication device via a grant-free transmission occasion, thereby conserving signaling overhead.

However, channel conditions in a wireless communication network may be dynamic and may change over time. Therefore, in some examples, the communication parameters for a grant-free transmission configuration (for example, for a CG configuration or an SPS configuration) may become suboptimal and/or may result in degraded communication performance as channel conditions change. For example, a network node may select the communication parameters based on, in response to, or otherwise associated with first channel conditions. However, if the wireless communication device transmits a signal using the communication parameters when experiencing second channel conditions, the signal may have degraded performance (for example, as compared to if the signal were transmitted when the wireless communication device is experiencing the first channel conditions). To improve the performance of grant-free transmissions, the network node may reconfigure or modify communication parameters as channel conditions change. However, the reconfiguration or modification of the communication parameters may consume network resources and/or processing resources (for example, may introduce signaling overhead). Additionally, the reconfiguration or modification of the communication parameters may increase latency associated with the wireless communication device transmitting via a grant-free transmission occasion.

### SUMMARY

Some aspects described herein relate to a user equipment (UE) for wireless communication. The UE may include a processing system that includes one or more processors and one or more memories coupled with the one or more processors. The processing system may be configured to cause the UE to receive a configured grant configuration that includes a resource allocation, the resource allocation indicating one or more parameters that are associated with one or more selection rules. The processing system may be configured to cause the UE to transmit one or more communications in accordance with values of respective parameters of the one or more parameters, the values being in accordance with one or more channel estimation parameters and the one or more selection rules.

Some aspects described herein relate to a network node for wireless communication. The network node may include a processing system that includes one or more processors and one or more memories coupled with the one or more processors. The processing system may be configured to cause the network node to transmit a configured grant configuration that includes a resource allocation, the resource allocation indicating one or more parameters that are associated with one or more selection rules. The processing system may be configured to cause the network node to receive one or more communications in accordance with values of respective parameters of the one or more parameters, the values being in accordance with one or more channel estimation parameters and the one or more selection rules.

Some aspects described herein relate to a method of wireless communication by a UE. The method may include receiving a configured grant configuration that includes a resource allocation, the resource allocation indicating one or more parameters that are associated with one or more selection rules. The method may include transmitting one or more communications in accordance with values of respective parameters of the one or more parameters, the values being in accordance with one or more channel estimation parameters and the one or more selection rules.

Some aspects described herein relate to a method of wireless communication by a network node. The method may include transmitting a configured grant configuration that includes a resource allocation, the resource allocation indicating one or more parameters that are associated with one or more selection rules. The method may include receiving one or more communications in accordance with values of respective parameters of the one or more parameters, the values being in accordance with one or more channel estimation parameters and the one or more selection rules.

Some aspects described herein relate to a non-transitory computer-readable medium that stores a set of instructions for wireless communication by a UE. The set of instructions, when executed by one or more processors of the UE, may cause the UE to receive a configured grant configuration that includes a resource allocation, the resource allocation indicating one or more parameters that are associated with one or more selection rules. The set of instructions, when executed by one or more processors of the UE, may cause the UE to transmit one or more communications in accordance with values of respective parameters of the one or more parameters, the values being in accordance with one or more channel estimation parameters and the one or more selection rules.

Some aspects described herein relate to a non-transitory computer-readable medium that stores a set of instructions for wireless communication by a network node. The set of instructions, when executed by one or more processors of the network node, may cause the network node to transmit a configured grant configuration that includes a resource allocation, the resource allocation indicating one or more parameters that are associated with one or more selection rules. The set of instructions, when executed by one or more processors of the network node, may cause the network node to receive one or more communications in accordance with values of respective parameters of the one or more parameters, the values being in accordance with one or more channel estimation parameters and the one or more selection rules.

Some aspects described herein relate to an apparatus for wireless communication. The apparatus may include means for receiving a configured grant configuration that includes a resource allocation, the resource allocation indicating one or more parameters that are associated with one or more selection rules. The apparatus may include means for transmitting one or more communications in accordance with values of respective parameters of the one or more parameters, the values being in accordance with one or more channel estimation parameters and the one or more selection rules.

Some aspects described herein relate to an apparatus for wireless communication. The apparatus may include means for transmitting a configured grant configuration that includes a resource allocation, the resource allocation indicating one or more parameters that are associated with one or more selection rules. The apparatus may include means for receiving one or more communications in accordance with values of respective parameters of the one or more parameters, the values being in accordance with one or more channel estimation parameters and the one or more selection rules.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of grant-free communications in accordance with the present disclosure.

FIG. 5 is a diagram of an example associated with a channel-condition-based configured grant configuration in accordance with the present disclosure.

FIG. 6 is a flowchart illustrating an example process performed, for example, at a UE or an apparatus of a UE that supports a channel-condition-based configured grant configuration in accordance with the present disclosure.

FIG. 7 is a flowchart illustrating an example process performed, for example, at a network node or an apparatus of a network node that supports a channel-condition-based configured grant configuration in accordance with the present disclosure.

FIG. 8 is a diagram of an example apparatus for wireless communication that supports a channel-condition-based configured grant configuration in accordance with the present disclosure.

FIG. 9 is a diagram of an example apparatus for wireless communication that supports a channel-condition-based configured grant configuration in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some examples, a wireless communication device may communicate via grant-free communications. A grant-free communication may include semi-persistent scheduling (SPS) communications (for example, downlink SPS communications) and/or configured grant (CG) communications (for example, uplink CG communications or sidelink CG communications). SPS communications may include periodic downlink communications that are configured for a user equipment (UE), such that a network node does not need to transmit (for example, directly or via one or more network nodes) separate downlink control information (DCI) to schedule each downlink communication, thereby conserving signaling overhead. CG communications may include periodic uplink communications or periodic sidelink communications that are configured for a UE, such that the network node does not need to transmit (for example, directly or via one or more other network nodes) separate control information (for example, DCI) to schedule each communication, thereby conserving signaling overhead. CG may also be referred to as configured scheduling or preconfigured resources (for example, preconfigured uplink resources).

In some examples, a CG configuration may be associated with a small data transfer (SDT) configuration (for example, the CG configuration may be a CG-SDT configuration). The UE may transmit data having a relatively small size (for example, small data) while operating in a radio resource control (RRC) inactive state or an RRC idle state (for example, without having to transition to an RRC connected state) using a CG occasion configured via a CG-SDT configuration, a preconfigured uplink resource (PUR), or another configured occasion.

The use of a CG-SDT may be useful for machine-type communication (MTC) UEs, Internet of things (IoT) UEs, and/or reduced capability (RedCap) UEs that may have relaxed peak throughput, latency, reliability, and/or other requirements relative to premium or reference UEs (for example, by allowing a grant-free transmission to occur while the UE is in an RRC idle state, an RRC inactive state, and/or another power-saving state). Although some examples are described herein in association with CG transmission and/or uplink communications, the same or similar techniques may be used for PUR communications, sidelink communications, and/or downlink communications (for example, for SPS communications).

A CG configuration (for example, a CG-SDT configuration) may enable reduced control signaling overhead because resources (for example, CG occasions) may be allocated or configured via a CG configuration, thereby reducing control signaling overhead that would have otherwise been associated with configuring each CG occasion separately. Further, by communicating using a CG occasion (for example, a CG-SDT occasion), a UE may conserve energy and/or improve energy efficiency because the UE may transmit a communication (for example, in accordance with parameters associated with the CG occasion) in the RRC inactive state or the RRC idle state, thereby conserving energy that would have otherwise been associated with transitioning to and/or operating in the RRC connected state to transmit the communication. Further, by configuring dedicated CG configurations for respective UEs, a likelihood of collisions or interference caused by transmissions from multiple UEs may be reduced. Additionally, by the network node configuring CG occasions for respective UEs in advance, an operational efficiency of a wireless communication network (for example, the wireless communication network 100) may be improved, such as when a large quantity of UEs (for example, IoT devices) are operating in the wireless communication network (for example, because the network node may coordinate resources used for transmissions by the large quantity of UEs in advance).

However, channel conditions in the wireless communication network may be dynamic and change over time. Therefore, in some examples, the communication parameters for a grant-free transmission (for example, for a CG configuration) may become suboptimal and/or may result in degraded communication performance. For example, a network node may select the communication parameters based on, in response to, or otherwise associated with first channel conditions. However, if the UE transmits a signal using the communication parameters when experiencing second channel conditions, the signal may have degraded performance (for example, as compared to if the signal were transmitted when the UE is experiencing the first channel conditions). To improve the performance of grant-free transmissions, the network node may reconfigure or modify communication parameters as channel conditions change. However, the reconfiguration or modification of the communication parameters may consume network resources and/or processing resources (for example, may introduce signaling overhead). Additionally, the reconfiguration or modification of the communication parameters may increase latency associated with the UE transmitting the grant-free transmissions.

Various aspects relate generally to channel-condition-based (or channel aware) grant-free transmission configurations. Some aspects more specifically relate to a CG configuration that is associated with one or more parameters that can be modified or selected (for example, by a UE) based on, in response to, or otherwise associated with current channel conditions experienced by the UE. In some aspects, the CG configuration may be associated with one or more rules that can be used to define or otherwise indicate values of one or more parameters for the CG configuration. For example, the UE may select, in accordance with the one or more rules, one or more values of respective parameters for the CG configuration based on, in response to, or otherwise associated with one or more channel estimation parameters. The UE may transmit one or more communications, via a transmission occasion configured via the CG configuration, in accordance with the one or more values of respective parameters for the CG configuration.

In some aspects, the CG configuration may include a range of values for a given parameter, such as for a frequency domain allocation (for example, a resource block (RB) allocation). For example, the CG configuration may indicate a set of candidate RBs available for use for a given CG occasion. The UE may select one or more RBs, from the set of candidate RBs, in accordance with the one or more rules and the one or more channel estimation parameters. The UE may transmit a communication via the given CG occasion via the one or more RBs. As another example, the UE may select a modulation and coding scheme (MCS) (for example, from one or more candidate MCSs) and/or a rank (for example, from one or more candidate ranks), among other examples, in accordance with the one or more rules and the one or more channel estimation parameters.

The UE and a network node (for example, in uplink CG scenarios) may identify or select the values of one or more parameters for the CG configuration. For example, the UE may obtain the one or more channel estimation parameters via one or more measurements of a reference signal, such as a downlink reference signal. The network node may obtain the one or more channel estimation parameters (for example, for a downlink channel) via one or more measurements of a reference signal, such as an uplink reference signal. The network node may identify the one or more channel estimation parameters for the downlink channel based on, or otherwise associated with, one or more measurements of the uplink reference signal (for example, due to channel reciprocity). In some aspects, the CG configuration may indicate a default configuration (for example, associated with one or more default values for respective parameters). The UE and the network node may use a modified CG configuration (for example, using one or more values for the respective parameters selected by the UE and/or the network node in accordance with the one or more rules and the one or more channel estimation parameters) based on, in response to, or otherwise associated with a performance metric of the modified CG configuration being greater than a performance metric of the default CG configuration by an amount that satisfies a threshold.

Additionally or alternatively, the one or more channel estimation parameters used by the UE and the network node may be previously obtained or outdated (for example, may be from T slots prior to a current slot or may be from a previously communicated report from the UE).

Particular aspects of the subject matter described in this disclosure can be implemented to realize one or more of the following potential advantages. In some examples, the described techniques can be used to adaptively modify parameters for a CG configuration as channel conditions change. For example, by using values of respective parameters for the CG configuration that are based on, in response to, or otherwise associated with one or more channel estimation parameters, a performance of communications transmitted in accordance with the CG configuration may be improved. For example, by selecting values for one or more parameters (such as a frequency domain allocation, an MCS, and/or a rank) in accordance with the one or more channel estimation parameters and the one or more rules, a capacity (for example, a size of a payload) of communications transmitted in accordance with the CG configuration may be improved and/or a resource utilization may be improved.

In some aspects, the UE and/or the network node may increase the capacity and/or payload size of communications transmitted via one or more CG occasions by dynamically selecting the MCS and/or rank for the one or more CG occasions (for example, without modifying a frequency domain allocation). As another example, the UE and/or the network node may improve network resource utilization by dynamically selecting the MCS and/or rank for one or more CG occasions and modifying the frequency domain allocation based on, in response to, or otherwise associated with, the selected MCS and/or rank. In some aspects, the UE and/or the network node, by performing one or more operations described herein, may reduce the likelihood of a mismatch between channel estimation parameter(s) used by the UE and channel estimation parameter(s) by the network node to identify or select the one or more values of respective parameters for the CG configuration. By the UE and/or the network node reducing the likelihood of the mismatch between the channel estimation parameter(s), the likelihood that the UE and the network node are using the same values for the respective parameters for the CG configuration is improved. This improves the performance of communications between the UE and the network node and reduces the likelihood of degraded performance that would otherwise be caused by the UE and the network node are using different values for the respective parameters for the CG configuration. The one or more operations may include using a modified CG configuration based on, in response to, or otherwise associated with a performance metric of the modified CG configuration being greater than a performance metric of the default CG configuration by an amount that satisfies a threshold.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

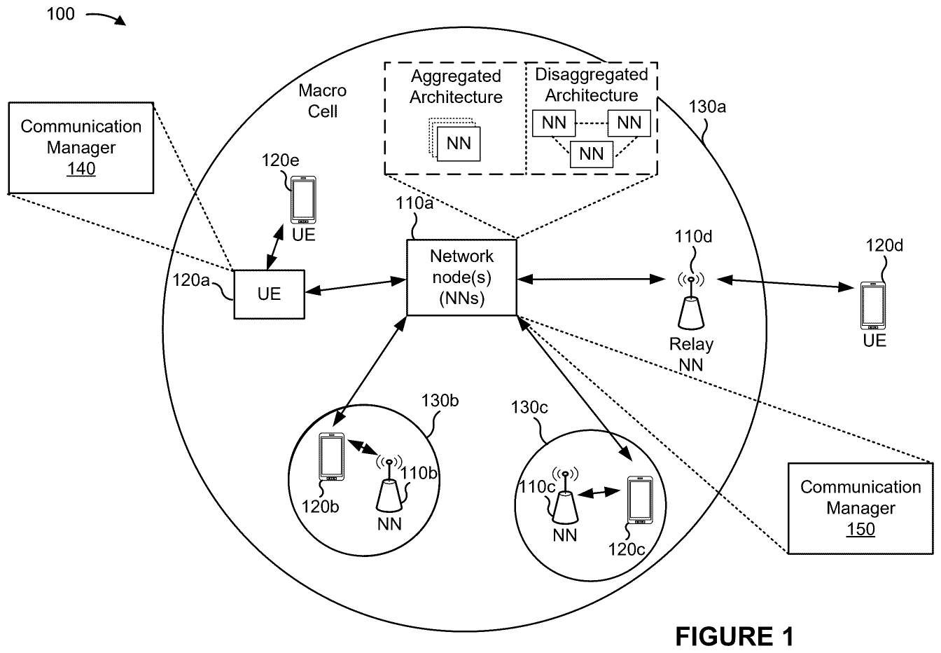

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In such examples, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced cMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband loT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c ) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive a configured grant configuration that includes a resource allocation, the resource allocation indicating one or more parameters that are associated with one or more selection rules; and transmit one or more communications in accordance with values of respective parameters of the one or more parameters, the values being in accordance with one or more channel estimation parameters and the one or more selection rules. Additionally or alternatively, the communication manager 140 may perform one or more other operations described herein.

In some aspects, the network node 110 may include a communication manager 150. As described in more detail elsewhere herein, the communication manager 150 may transmit a configured grant configuration that includes a resource allocation, the resource allocation indicating one or more parameters that are associated with one or more selection rules; and receive one or more communications in accordance with values of respective parameters of the one or more parameters, the values being in accordance with one or more channel estimation parameters and the one or more selection rules. Additionally or alternatively, the communication manager 150 may perform one or more other operations described herein.

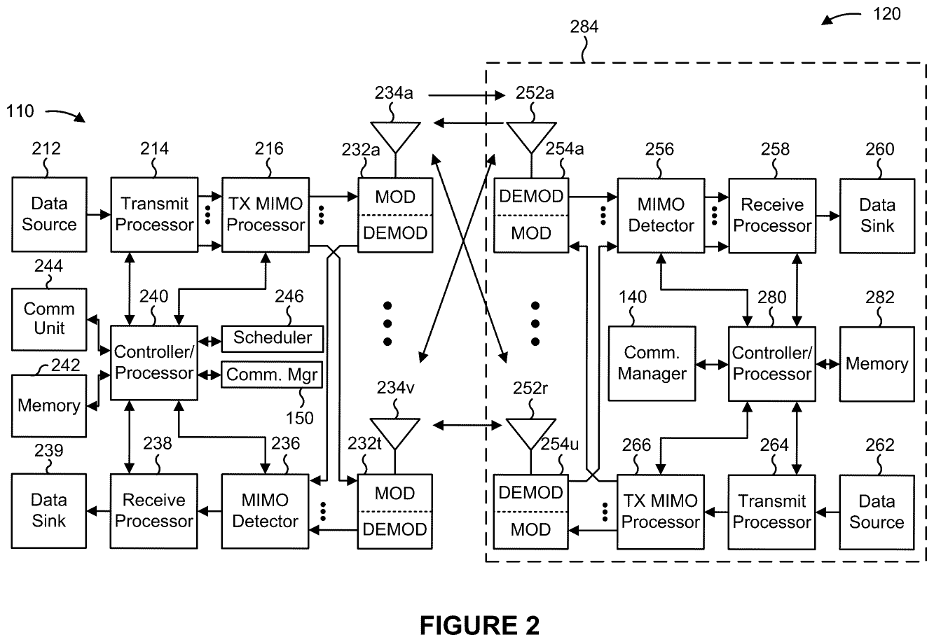

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different quantities of antenna elements. For example, a UE 120 may include a single antenna element, two antenna clements, four antenna elements, eight antenna elements, or a different quantity of antenna clements. As another example, a network node 110 may include eight antenna elements, 24 antenna elements, 64 antenna elements, 128 antenna elements, or a different quantity of antenna elements. Generally, a larger quantity of antenna elements may provide increased control over parameters for beam generation relative to a smaller quantity of antenna elements, whereas a smaller quantity of antenna clements may be less complex to implement and may use less power than a larger quantity of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

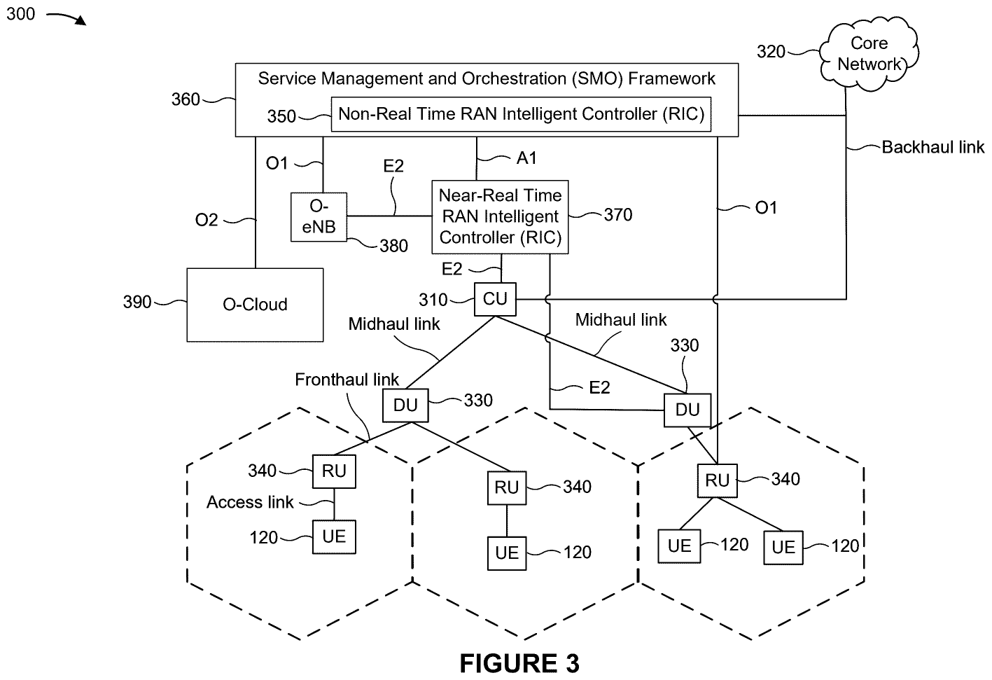

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6 RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

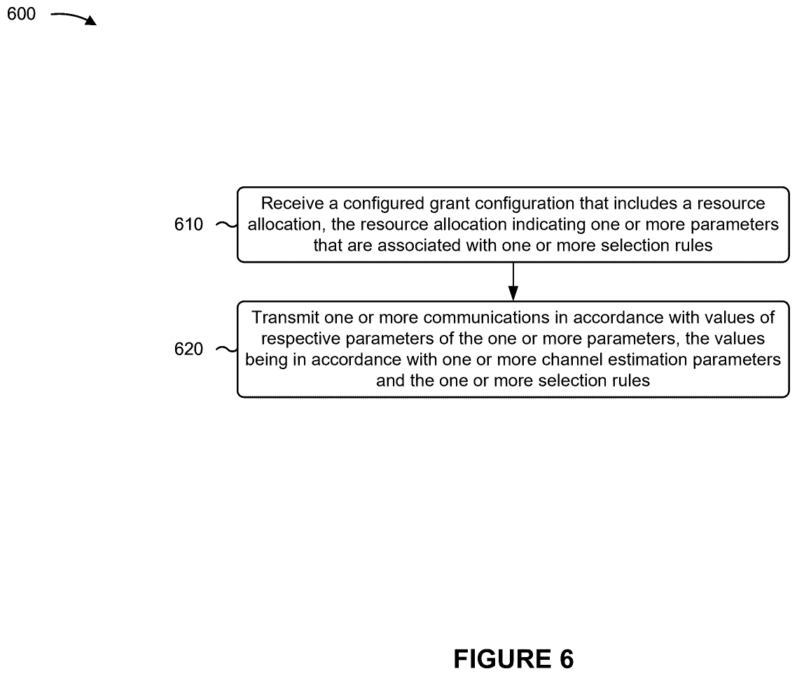

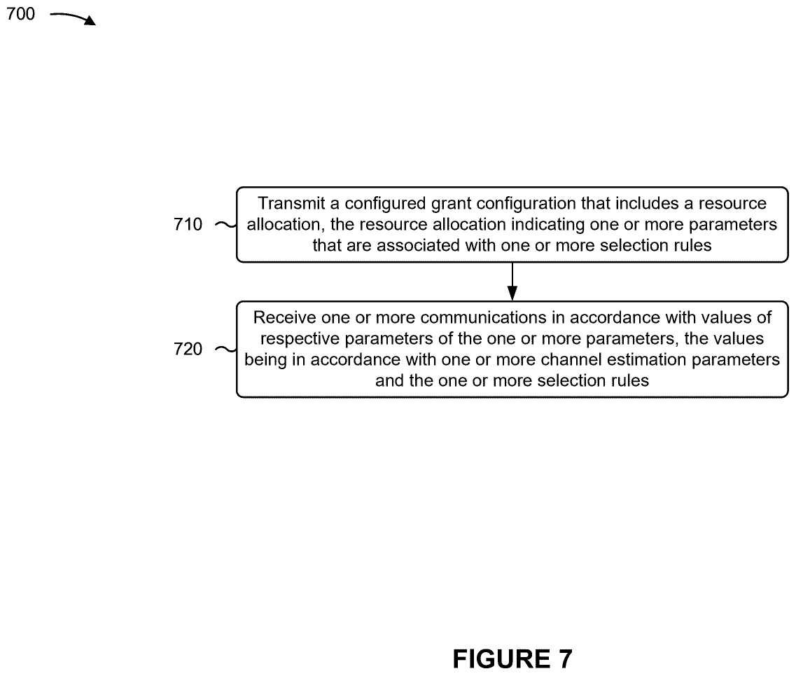

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a channel-condition-based configured grant configuration, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 600 of FIG. 6, process 700 of FIG. 7, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

In some aspects, the UE 120 includes means for receiving a configured grant configuration that includes a resource allocation, the resource allocation indicating one or more parameters that are associated with one or more selection rules; and/or means for transmitting one or more communications in accordance with values of respective parameters of the one or more parameters, the values being in accordance with one or more channel estimation parameters and the one or more selection rules. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a configured grant configuration that includes a resource allocation, the resource allocation indicating one or more parameters that are associated with one or more selection rules; and/or means for receiving one or more communications in accordance with values of respective parameters of the one or more parameters, the values being in accordance with one or more channel estimation parameters and the one or more selection rules. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

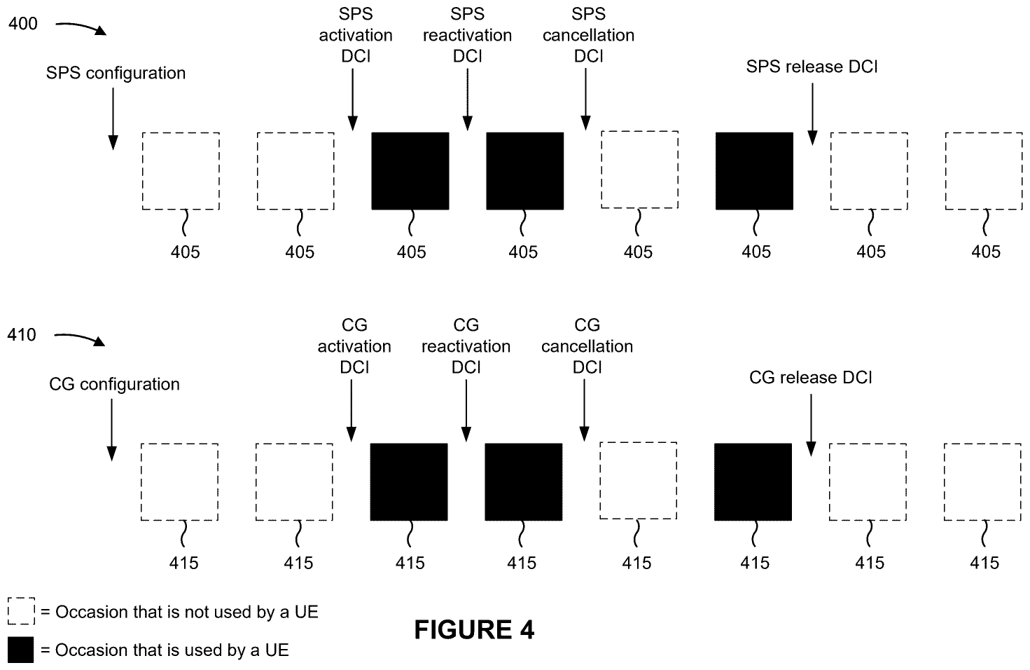

FIG. 4 is a diagram illustrating an example of grant-free communications in accordance with the present disclosure. As shown in FIG. 4, the grant-free communications may include downlink semi-persistent scheduling (SPS) communications 400 and/or of uplink configured grant (CG) communications 410. SPS communications may include periodic downlink communications that are configured for a UE, such that a network node does not need to transmit (for example, directly or via one or more network nodes) separate DCI to schedule each downlink communication, thereby conserving signaling overhead. CG communications may include periodic uplink communications or periodic sidelink communications that are configured for a UE, such that the network node does not need to transmit (for example, directly or via one or more network nodes) separate control information (for example, DCI) to schedule each communication, thereby conserving signaling overhead. CG may also be referred to as configured scheduling or preconfigured resources (for example, preconfigured uplink resources).

As shown in FIG. 4, a UE may be configured with an SPS configuration for SPS communications. For example, the UE may receive the SPS configuration via an RRC message transmitted by a network node (for example, directly to the UE or via one or more network nodes). The SPS configuration may indicate a resource allocation associated with SPS downlink communications (for example, in a time domain, frequency domain, spatial domain, and/or code domain) and a periodicity at which the resource allocation is repeated, resulting in periodically reoccurring scheduled SPS occasions 405 for the UE. As used herein, “occasion” refers to one or more time domain resources and/or one or more frequency domain resources that are available (for example, configured) for a communication (for example, an SPS occasion 405 may be configured for downlink communication(s) and a CG occasion may be configured for uplink communication(s) or sidelink communication(s)).

The network node may transmit SPS activation DCI to the UE (for example, directly or via one or more network nodes) to activate the SPS configuration for the UE. The network node may indicate, in the SPS activation DCI, communication parameters, such as an MCS, a resource block (RB) allocation, and/or antenna ports, for the SPS PDSCH communications to be transmitted in the scheduled SPS occasions 405. The UE may begin monitoring the SPS occasions 405 based at least in part on receiving the SPS activation DCI. For example, beginning with a next scheduled SPS occasion 405 subsequent to receiving the SPS activation DCI, the UE may monitor the scheduled SPS occasions 405 to decode PDSCH communications using the communication parameters indicated in the SPS activation DCI. The UE may refrain from monitoring configured SPS occasions 405 prior to receiving the SPS activation DCI.

The network node may transmit SPS reactivation DCI to the UE (for example, directly or via one or more network nodes) to change the communication parameters for the SPS PDSCH communications. Based at least in part on receiving the SPS reactivation DCI, the UE may begin monitoring the scheduled SPS occasions 405 using the communication parameters indicated in the SPS reactivation DCI. For example, beginning with a next scheduled SPS occasion 405 subsequent to receiving the SPS reactivation DCI, the UE may monitor the scheduled SPS occasions 405 to decode PDSCH communications based on the communication parameters indicated in the SPS reactivation DCI.

In some examples, such as when is the network node does not have downlink traffic to transmit to the UE, the network node may transmit SPS cancellation DCI to the UE (for example, directly or via one or more network nodes) to temporarily cancel or deactivate one or more subsequent SPS occasions 405 for the UE. The SPS cancellation DCI may deactivate only a subsequent one SPS occasion 405 or a subsequent N SPS occasions 405 (where N is an integer). SPS occasions 405 after the one or more (for example, N) SPS occasions 405 subsequent to the SPS cancellation DCI may remain activated. Based at least in part on receiving the SPS cancellation DCI, the UE may refrain from monitoring the one or more (for example, N) SPS occasions 405 subsequent to receiving the SPS cancellation DCI. As shown in example 400, the SPS cancellation DCI cancels one subsequent SPS occasion 405 for the UE. After the SPS occasion 405 (or N SPS occasions) subsequent to receiving the SPS cancellation DCI, the UE may automatically resume monitoring the scheduled SPS occasions 405.

The network node may transmit SPS release DCI to the UE (for example, directly or via one or more network nodes) to deactivate the SPS configuration for the UE. The UE may stop monitoring the scheduled SPS occasions 405 based at least in part on receiving the SPS release DCI. For example, the UE may refrain from monitoring any scheduled SPS occasions 405 until another SPS activation DCI is received by the UE. Whereas the SPS cancellation DCI may deactivate only a subsequent one SPS occasion 405 or a subsequent N SPS occasions 405, the SPS release DCI deactivates all subsequent SPS occasions 405 for a given SPS configuration for the UE until the given SPS configuration is activated again by a new SPS activation DCI.

As shown in FIG. 4, a UE may be configured with a CG configuration for CG communications. For example, the UE may receive the CG configuration via an RRC message transmitted by a network node (for example, directly to the UE or via one or more network nodes). The CG configuration may indicate a resource allocation associated with CG uplink communications or CG sidelink communications (for example, in a time domain, frequency domain, spatial domain, and/or code domain) and a periodicity at which the resource allocation is repeated, resulting in periodically reoccurring scheduled CG occasions 415 for the UE. In some examples, the CG configuration may identify a resource pool or multiple resource pools that are available to the UE for an uplink transmission. The CG configuration may configure contention-frec CG communications (for example, where resources are dedicated for the UE to transmit uplink communications) or contention-based CG communications (for example, where the UE contends for access to a channel in the configured resource allocation, such as by using a channel access procedure or a channel sensing procedure).

The network node may transmit CG activation DCI to the UE (for example, directly or via one or more network nodes) to activate the CG configuration for the UE. The network node may indicate, in the CG activation DCI, communication parameters, such as an MCS, an RB allocation, and/or antenna ports, for the CG communications to be transmitted in the scheduled CG occasions 415. The UE may begin transmitting in the CG occasions 415 based at least in part on receiving the CG activation DCI. For example, beginning with a next scheduled CG occasion 415 subsequent to receiving the CG activation DCI, the UE may transmit a communication in the scheduled CG occasions 415 using the communication parameters indicated in the CG activation DCI. The UE may refrain from transmitting in configured CG occasions 415 prior to receiving the CG activation DCI.

The network node may transmit CG reactivation DCI to the UE (for example, directly or via one or more network nodes) to change the communication parameters for the CG communications. Based at least in part on receiving the CG reactivation DCI, and the UE may begin transmitting in the scheduled CG occasions 415 using the communication parameters indicated in the CG reactivation DCI. For example, beginning with a next scheduled CG occasion 415 subsequent to receiving the CG reactivation DCI, the UE may transmit communications in the scheduled CG occasions 415 based at least in part on the communication parameters indicated in the CG reactivation DCI.

In some examples, such as when the network node needs to override a scheduled CG communication for a higher priority communication, the network node may transmit CG cancellation DCI to the UE (for example, directly or via one or more network nodes) to temporarily cancel or deactivate one or more subsequent CG occasions 415 for the UE. The CG cancellation DCI may deactivate only a subsequent one CG occasion 415 or a subsequent M CG occasions 415 (where M is an integer). CG occasions 415 after the one or more (for example, M) CG occasions 415 subsequent to the CG cancellation DCI may remain activated. Based at least in part on receiving the CG cancellation DCI, the UE may refrain from transmitting in the one or more (for example, M) CG occasions 415 subsequent to receiving the CG cancellation DCI. As shown in example 410, the CG cancellation DCI cancels one subsequent CG occasion 415 for the UE. After the CG occasion 415 (or M CG occasions) subsequent to receiving the CG cancellation DCI, the UE may automatically resume transmission in the scheduled CG occasions 415.

The network node may transmit CG release DCI to the UE (for example, directly or via one or more network nodes) to deactivate the CG configuration for the UE. The UE may stop transmitting in the scheduled CG occasions 415 based at least in part on receiving the CG release DCI. For example, the UE may refrain from transmitting in any scheduled CG occasions 415 until another CG activation DCI is received by the UE. Whereas the CG cancellation DCI may deactivate only a subsequent one CG occasion 415 or a subsequent M CG occasions 415, the CG release DCI deactivates all subsequent CG occasions 415 for a given CG configuration for the UE until the given CG configuration is activated again by a new CG activation DCI.

In some examples, a CG configuration may be associated with a small data transfer (SDT) configuration (for example, the CG configuration may be a CG-SDT configuration). The UE may transmit data having a relatively small size (for example, small data) while operating in an RRC inactive state or an RRC idle state (for example, without having to transition to an RRC connected state) using a CG occasion configured via a CG-SDT configuration, a preconfigured uplink resource (PUR), or another configured occasion. A CG communication may also be referred to as a mobile originated (MO) CG communication.

For example, a previously configured resource for a UE may be referred to as CG-SDT occasion. The CG-SDT occasion, which may be applicable to a UE in an RRC inactive or an RRC idle state, may be associated with a beam-specific resource configuration. The CG-SDT occasion may be associated with beam-specific feedback (for example, a PDCCH and/or a PDSCH that is quasi co-located (QCL'ed) with a downlink reference signal, such as a synchronization signal block (SSB) or tracking reference signal (TRS)). The use of a CG-SDT may be useful for MTC UEs, IoT UEs, and/or RedCap UEs that may have relaxed peak throughput, latency, reliability, and/or other requirements relative to premium or reference UEs (for example, by allowing a grant-free transmission to occur while the UE is in an RRC idle state, an RRC inactive state, and/or another power-saving state). Although some aspects described herein relate to CG transmission and/or uplink communications, the same or similar techniques may be used for PUR communications, sidelink communications, and/or downlink communications (for example, for SPS communications).

In some aspects, a network node may configure one or more CG-SDT occasions for a UE while the UE is in an RRC connected state, when transmitting an RRC release message to the UE, and/or in a downlink message associated with a random access channel (RACH) procedure, among other examples. In some aspects, a CG-SDT occasion may be configured as a dedicated CG-SDT and/or a contention-free dedicated CG-SDT, a contention-free shared CG-SDT, and/or a contention-based shared CG-SDT, among other examples.

A CG configuration (for example, a CG-SDT configuration) may enable reduced control signaling overhead because resources (for example, CG occasions) may be allocated or configured via a CG configuration, thereby reducing control signaling overhead that would have otherwise been associated with configuring each CG occasion separately. Further, by communicating using a CG occasion (for example, a CG-SDT occasion), a UE may conserve energy and/or improve energy efficiency because the UE may transmit a communication (for example, in accordance with parameters associated with the CG occasion) in the RRC inactive state or the RRC idle state, thereby conserving energy that would have otherwise been associated with transitioning to and/or operating in the RRC connected state to transmit the communication. Further, by configuring dedicated CG configurations for respective UEs, a likelihood of collisions or interference caused by transmissions from multiple UEs may be reduced. Further, by the network node configuring CG occasions for respective UEs in advance, an operational efficiency of a wireless communication network (for example, the wireless communication network 100) may be improved, such as when a large quantity of UEs (for example, IoT devices) are operating in the wireless communication network (for example, because the network node may coordinate resources used for transmissions by the large quantity of UEs in advance).

However, channel conditions in the wireless communication network may be dynamic and may change over time. Therefore, in some examples, the communication parameters for a grant-free transmission (for example, for a CG configuration) may become suboptimal and/or may result in degraded communication performance. For example, a network node may select the communication parameters based on, in response to, or otherwise associated with first channel conditions. However, if the UE transmits a signal using the communication parameters when experiencing second channel conditions, the signal may have degraded performance (for example, as compared to the signal being transmitted when the UE is experiencing the first channel conditions). To improve the performance of grant-free transmissions, the network node may reconfigure or modify communication parameters as channel conditions change. However, the reconfiguration or modification of the communication parameters May consume network resources and/or processing resources (for example, may introduce signaling overhead). Additionally, the reconfiguration or modification of the communication parameters may increase latency associated with the UE transmitting the grant-free transmissions.

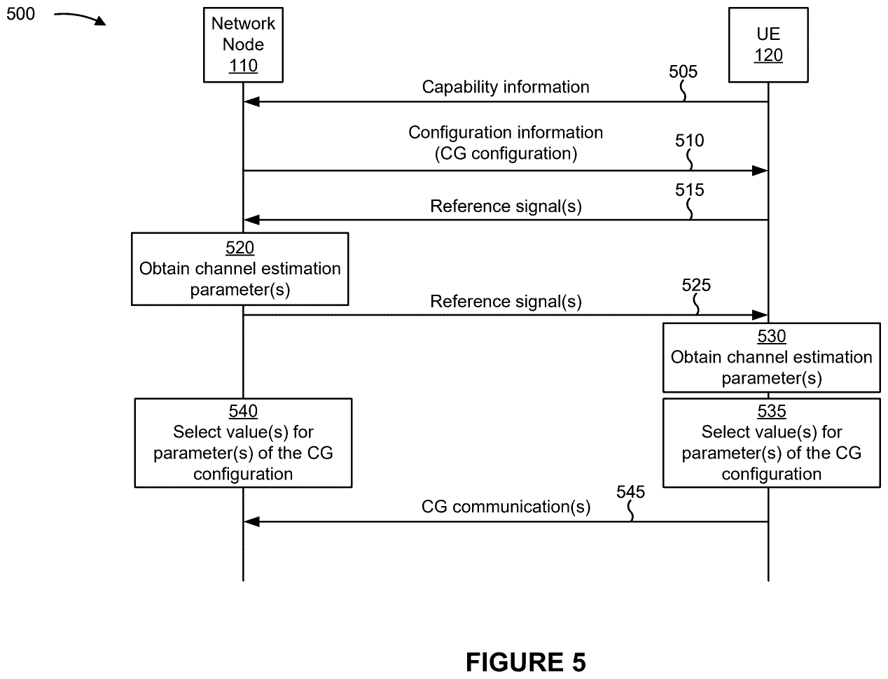

FIG. 5 is a diagram of an example 500 associated with a channel-condition-based configured grant configuration in accordance with the present disclosure. As shown in FIG. 5, one or more network nodes 110 (for example, a base station, a CU, a DU, and/or an RU) may communicate with a UE 120. In some aspects, the network node and the UE may be part of a wireless network (for example, wireless network 100). The UE 120 and the network node(s) 110 may have established a wireless connection prior to operations shown in FIG. 5.

In some aspects, in a first operation 505, the UE 120 may transmit capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), and/or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature and/or one or more parameters related to the feature. For example, the capability information may indicate a capability and/or parameter for adaptively modifying one or more parameters of a CG configuration (for example, based on, in response to, or otherwise associated with channel conditions). As another example, the capability information may indicate a capability and/or parameter for supporting a channel-aware resource allocation for a CG configuration.

One or more operations described herein may be based on capability information. For example, the UE 120 may transmit a CG communication in accordance with the capability information, or may receive configuration information (for example, a CG configuration) that is in accordance with the capability information. In other aspects, the network node 110 may configure the UE 120 without receiving the capability information.

In some aspects, the capability information may indicate UE support for selecting or dynamically updating (for example, based on, in response to, or otherwise associated with current channel conditions) a frequency domain resource allocation, a time domain resource allocation, and/or a time domain periodicity, among other examples, for one or more CG occasions for a type 1 CG configuration or a contention-free CG configuration (for example, for a CG configuration type associated with a dedicated resource allocation for the UE 120). In some aspects, the capability information may indicate UE support for selecting or dynamically updating one or more transmission parameters for one or more CG occasions, such as an MCS, a rank, a transmit power, among other examples.

In a second operation 510, the network node 110 may transmit, and the UE 120 may receive, configuration information. In some aspects, the UE 120 may receive the configuration information via one or more of system information signaling (for example, a master information block (MIB) and/or a system information block (SIB), among other examples), RRC signaling, MAC signaling (for example, one or more MAC-CEs), and/or lower-layer signaling (for example, DCI), among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (for example, an indication described herein) may include a dynamic indication, such as one or more MAC-CEs and/or one or more DCI messages, among other examples.

In some aspects, the configuration information may indicate that the UE 120 is to dynamically select and/or update values for respective parameters of a grant-free transmission configuration based on, in response to, or otherwise associated with one or more rules and one or more channel estimation parameters. For example, the configuration information may indicate that the UE 120 is to dynamically select and/or update values for respective parameters of a CG configuration (for example, an uplink CG configuration or a sidelink CG configuration) or an SPS configuration. Although some examples are described herein in connection with a grant-free transmission configuration for which the UE 120 transmits one or more communications, the techniques and aspects described herein may be similarly applied for a grant-free transmission configuration for which the UE 120 receives one or more communications (for example, for an SPS configuration).

For example, the configuration information may include a grant-free transmission configuration, such as a CG configuration or an SPS configuration. For example, the configuration information may include one or more IEs indicating configuration parameters for the grant-free transmission configuration. The grant-free transmission configuration may be a contention-free configuration in which a resource allocation is dedicated for the UE 120. For example, the configuration information may include a contention-free CG communication with resources dedicated for the UE to transmit uplink communications. In such examples, the CG configuration may indicate a resource allocation (for example, in a time domain, frequency domain, spatial domain, and/or code domain) dedicated for the UE 120 to use to transmit communications. A contention-free configuration differs from a contention-based configuration in which one or more resource pools are configured that are available for multiple UEs to use to transmit communications.

As an example, the configuration information may include a configured scheduling configuration for uplink or sidelink (for example, a CG configuration). The configured scheduling configuration may be a type 1 configured scheduling configuration (for example, a contention-free configured scheduling configuration). The configuration information may configure one or more periodic CG occasions available for the UE 120 to use for transmissions. For example, the configuration information may configure one or more periodic CG occasions via one or more IEs, such as a ConfiguredGrantConfig IE. The one or more IEs may include fields for respective parameters (for example, configuration parameters), such as a resource allocation (for example, a time domain resource allocation and/or a frequency domain resource allocation), an MCS, a rank, a quantity of hybrid automatic repeat request (HARQ) processes, one or more transmit power parameters, and/or a DMRS configuration, among other examples.

In some aspects, the configuration information may indicate that values or information for one or more of the parameters of the CG configuration (or an SPS configuration) are modifiable or selectable by the UE 120. For example, for a given parameter, the configuration information may indicate a range of values or a set of candidate values for the given parameter. As an example, a dedicated resource allocation for the UE 120, as indicated by the configuration information, may include a set of candidate resources (for example, one or more candidate time-frequency resources (for example, RBs or resource elements)). As used herein, “time-frequency resource” refers to a radio resource that can be used for transmission by a wireless communication device, such as the UE 120 or the network node 110. For example, a time-frequency resource may include a frequency domain resource and/or a time domain resource. As an example, a time-frequency resource may include a resource block, a resource element, and/or a resource element group, among other examples. As another example, a time-frequency resource may include one or more subcarriers, one or more symbols (for example, an OFDM symbol), a mini-slot, a slot, a subframe, a frame, and/or a control resource set (CORESET), among other examples.

For example, time-frequency resources in a radio access network may be partitioned into RBs. An RB is sometimes referred to as a physical resource block (PRB). An RB includes a set of subcarriers (for example, 12 subcarriers) and a set of symbols (for example, 14 symbols) that are schedulable by the network node 110 as a unit. In some aspects, an RB may include a set of subcarriers in a single slot. A single time-frequency resource included in an RB may be referred to as a resource element (RE). An RE may include a single subcarrier (for example, in frequency) and a single symbol (for example, in time). A symbol may be referred to as an OFDM symbol. An RE may be used to transmit one modulated symbol, which may be a real value or a complex valuc.

The configuration information may indicate a set of one or more frequency domain resources (for example, a set of candidate RBs) for the CG configuration that are dedicated to (or allocated to) the UE 120. For example, a CG configuration may include a channel-aware resource allocation that configures a set of resources that are available for selection by the UE 120. The channel-aware resource allocation may indicate a set of RBs (for example, an RB range) that defines all candidate RBs that are available or selectable for one or more CG occasions. In some aspects, the channel-aware resource allocation may indicate a quantity of RBs that are to be selected by the UE 120 for a given CG occasion (for example, from the candidate RBs that are available or selectable). In this way, the configuration information may enable the UE 120 to vary or change resource allocation for CG occasions over time in accordance with varying channel conditions, as described in more detail elsewhere herein. This may improve the performance of CG communications (for example, increase the capacity) and/or may improve network resource utilization, among other examples.

In some aspects, the configuration information may indicate one or more transmission parameters configured for the CG configuration. The configuration information may indicate that values or information for the one or more transmission parameters are selectable or modifiable by the UE 120. For example, the one or more transmission parameters may include an MCS. The configuration information may indicate one or more candidate MCSs for the CG configuration (for example, that are selectable by the UE 120 based on, or otherwise associated with, channel conditions). As another example, the configuration information may indicate one or more candidate ranks for the CG configuration.

In some aspects, the configuration information may indicate a time domain periodicity associated with the CG configuration. The time domain periodicity may indicate an amount of time between periodic CG occasions configured by the CG configuration. In some aspects, the configuration information may indicate that the time domain periodicity is selectable or modifiable by the UE 120. For example, the configuration information may indicate a range of values for the time domain periodicity and/or a set of candidate time domain periodicities for the CG configuration.

In some aspects, the configuration information may indicate a default configuration for the CG configuration. The default configuration may indicate default values for one or more parameters of the CG configuration (for example, for parameter(s) that are otherwise modifiable by the UE 120). For example, the default configuration may indicate a CG configuration independent of channel conditions (for example, prior to selecting or modifying value(s) for one or more parameters).

In some aspects, the configuration information may indicate one or more rules associated with selecting or modifying values of one or more parameters of the CG configuration. In other aspects, the configuration information may not indicate the one or more rules. In such examples, the one or more rules may be defined, or otherwise fixed, by a wireless communication standard, such as the 3GPP. In some aspects, the one or more rules may include rules for respective parameters of the one or more parameters that are modifiable by the UE 120. The one or more rules may be associated with channel estimation parameters (for example, channel conditions). For example, the one or more rules may define how, if, and/or when the UE 120 is to select or modify a value of a parameter of the CG configuration based on, or otherwise associated with, one or more channel estimation parameters.

As an example, the one or more rules may include one or more rules for selecting and/or modifying a resource allocation associated with the CG configuration. For example, the one or more rules may indicate that the UE 120 is to select one or more RBs that result in a highest capacity or a highest value for a signal parameter (for example, signal-to-noise ratio (SNR) or another signal parameter) in accordance with the one or more channel estimation parameters (for example, that result in the highest capacity or the highest value for a signal parameter for the current channel conditions). As another example, a rule may indicate that the UE 120 is to select a set of L continuous or contiguous RBs that result in a highest capacity or a highest value for a signal parameter (for example, where a value of L is indicated by the configuration information). As another example, a rule may indicate that the UE 120 is to select RBs that have a capacity or value of a signal parameter (for example, SNR) that satisfies a threshold. In some aspects, the one or more rules may include rules for excluding RBs or REs from selection. For example, the one or more rules may indicate that the UE 120 is to exclude REs (for example, from any selected or allocated RBs) that have a capacity or value of a signal parameter that does not satisfy a threshold. “Excluding” a resource (for example, an RE) refers to the UE 120 refraining from transmitting using the resource or refraining from selecting the resource for a given CG occasion.

In some aspects, the one or more rules may include one or more rules for selecting and/or modifying transmission parameters associated with the CG configuration. For example, the one or more rules may include one or more rules associated with selecting and/or modifying an MCS for the CG configuration. As another example, the one or more rules may include one or more rules associated with selecting and/or modifying a rank for the CG configuration.

The UE 120 may configure itself based at least in part on the configuration information. In some aspects, the UE 120 may be configured to perform one or more operations described herein based at least in part on the configuration information.

In some aspects, the network node 110 may transmit, and the UE 120 may receive, a dynamic indication that activates or enables the channel-based or channel-aware CG configuration. For example, prior to receiving the dynamic indication, the UE 120 may use the default configuration for the CG configuration. After receiving the dynamic indication, the UE 120 may adaptively select or modify one or more values for one or more parameters of the CG configuration, as described in more detail elsewhere herein. The dynamic indication may be communicated via Layer 2 signaling, Layer 1 signaling, MAC signaling (for example, one or more MAC-CEs), and/or DCI, among other examples.

In some aspects, the network node 110 may transmit, and the UE 120 may receive, a dynamic indication that deactivates or disables the channel-based or channel-aware CG configuration. For example, after receiving the dynamic indication that deactivates or disables the channel-based or channel-aware CG configuration, the UE 120 may use the default configuration for the CG configuration.

For example, the network node 110 may activate the channel-based or channel-aware CG configuration based on, in response to, or otherwise associated with detecting that channel conditions of a channel associated with communication between the UE 120 and the network node 110 are changing frequently. This enables the UE 120 to dynamically adapt the resource allocation and/or transmission parameters for one or more CG communications to increase capacity, improve performance, and/or improve network resource utilization, among other examples. As another example, the network node 110 may deactivate the channel-based or channel-aware CG configuration based on, in response to, or otherwise associated with detecting that channel conditions of a channel associated with communication between the UE 120 and the network node 110 are relatively stable. This may reduce the complexity associated with identifying and/or selecting the values of the one or more parameters and/or with decoding the CG communications.

In a third operation 515, the UE 120 may transmit, and the network node 110 may receive, one or more reference signals. The one or more reference signals may be uplink reference signals. For example, the one or more reference signals may include a sounding reference signal (SRS), a DMRS (for example, a PUSCH DMRS or a PUCCH DMRS), or a phase tracking reference signal (PTRS), among other examples. For example, the network node 110 may measure or otherwise process the one or more reference signals for uplink channel estimation. For example, an SRS may carry information used for uplink channel estimation, which may be used by the network node 110 to select or identify value(s) of parameters of the CG configuration used by the UE 120. The network node 110 may configure one or more SRS resource sets for the UE 120, and the UE 120 may transmit SRSs on the configured SRS resource sets. An SRS resource set may have a configured usage, such as uplink CSI acquisition, downlink CSI acquisition for reciprocity-based operations, or uplink beam management, among other examples.

In a fourth operation 520, the network node 110 may obtain or determine one or more channel estimation parameters. For example, the network node 110 may measure the SRSs, may perform channel estimation based at least in part on the measurements, and may use the SRS measurements to select or identify value(s) of parameters of the CG configuration used by the UE 120. The one or more channel estimation parameters may include an SNR, channel capacity, and/or one or more channel estimation matrix parameters (for example, an estimated channel matrix, and/or one or more eigenvalues of the estimated channel matrix), a channel quality indicator (CQI), a precoding matrix indicator (PMI), a CSI-RS resource indicator (CRI), a layer indicator (LI), a rank indicator (RI), or a reference signal received power (RSRP), among other examples. In other examples, the network node 110 may perform channel estimation based at least in part on the measurements of one or more DMRSs, and may use the DMRS measurements to select or identify value(s) of parameters of the CG configuration used by the UE 120.

In a fifth operation 525, the network node 110 may transmit, and the UE 120 may receive, one or more reference signals. The one or more reference signals may be downlink reference signals. The UE 120 may use measurement(s) of the one or more reference signals to obtain one or more channel estimation parameters of a downlink channel (for example, in a sixth operation 530). The one or more downlink reference signals may include an SSB, a CSI reference signal (CSI-RS), a DMRS, a positioning reference signal (PRS), and/or a PTRS, among other examples. For example, the one or more downlink reference signals may carry information used for downlink channel estimation (for example, downlink CSI acquisition), which may be used for scheduling, link adaptation, or beam management, among other examples. For example, the network node 110 may configure a set of CSI-RSs for the UE 120, and the UE 120 may measure the configured set of CSI-RSs. In the sixth operation 530, based at least in part on the measurements, the UE 120 may perform channel estimation to obtain one or more channel estimation parameters, such as an SNR, a channel capacity, and/or one or more channel estimation matrix parameters (for example, an estimated channel matrix, and/or one or more eigenvalues of the estimated channel matrix), a CQI, a PMI, a CRI, an LI, an RI, or an RSRP, among other examples.

In some aspects, the UE 120 may transmit, and the network node 110 may receive, a report indicating the channel estimation parameters (for example, in a CSI report). In other aspects, the network node 110 may determine channel conditions (for example, one or more channel estimation parameters) for the downlink channel using the one or more channel estimation parameters associated with the uplink channel (for example, obtained or determined by the network node 110 in the fourth operation 520). The UE 120 and the network node may obtain or track channel conditions (for example, as described in connection with the fourth operation 520 and the sixth operation 530) periodically, such as once every time unit. The time unit may be one or more symbols, a mini-slot, a slot, multiple slots, a subframe, a frame, X milliseconds, or another time unit.

In a seventh operation 535, the UE 120 may select one or more values for one or more parameters of the CG configuration. For example, the UE 120 may select the one or more values for one or more parameters of the CG configuration based on, in response to, in accordance with, or otherwise associated with the one or more channel estimation parameters (for example, obtained via the sixth operation 530). The UE 120 may select the one or more values in accordance with the one or more channel estimation parameters and the one or more rules. In other examples, such as for SPS configurations, the UE 120 may select the one or more values based on, in response to, in accordance with, or otherwise associated with one or more channel estimation parameters for the uplink channel (for example, that the UE 120 determines based on the one or more channel estimation parameters obtained via the sixth operation 530).

For example, the UE 120 may determine or select the one or more values for one or more parameters of the CG configuration for one or more CG occasions. For example, the UE 120 may perform the seventh operation prior to a time interval (for example, a slot or subframe) during which a CG occasion is configured to occur.

The UE 120 may determine or select one or more values for a resource allocation associated with the CG configuration in accordance with the one or more channel estimation parameters and the one or more rules. For example, the UE 120 may select one or more RBs from a set of RBs indicated by the CG configuration. The one or more RBs may be used for one or more CG occasions. For example, the UE 120 may select L RBs from a set of P configured RBs for the CG configuration (for example, where P is greater than or equal to L).

For example, the UE 120 may select L RBs from a set of P configured RBs that are estimated to result in the highest capacity and/or SNR, where the capacity and/or SNR are determined based on the one or more channel estimation parameters. In such examples, a value of L may be fixed (for example, via the CG configuration). The L RBs may be contiguous or non-contiguous in the time domain and/or in the frequency domain. For example, the L RBs may include one or more gaps in the time domain and/or one or more gaps in the frequency domain.

In other examples, the UE 120 may select L contiguous RBs from a set of P configured RBs that result in the highest capacity and/or SNR, where the capacity and/or SNR are determined based on the one or more channel estimation parameters. In such examples, a value of L may be fixed (for example, via the CG configuration). As another example, the UE 120 may select the RBs that are estimated to result in a capacity and/or SNR (for example, using the one or more channel estimation parameters) that satisfies a threshold. In such examples, the quantity of RBs selected (for example, L) for different CG occasions associated with the CG configuration may be dynamic and/or may not be fixed.

In some aspects, the UE 120 may exclude (for example, refrain from selecting and/or refrain from transmitting via) one or more time-frequency resources from the set of candidate time-frequency resources configured via the CG configuration. For example, time-frequency resources, from the set of candidate time-frequency resources, that are associated with values of the channel estimation parameter that do not satisfy a threshold may be excluded from the one or more time-frequency resources. As an example, the UE 120 may select one or more time-frequency resources (for example, one or more RBs) for one or more CG occasions, as described in more detail elsewhere herein. The UE 120 may exclude the frequency domain resource(s) from the set of candidate frequency domain resources configured via the CG configuration when selecting the one or more time-frequency resources. As another example, the UE 120 may exclude the frequency domain resource(s) from the one or more time-frequency resources selected by the UE 120. For example, the UE 120 may exclude one or more time-frequency resources (for example, one or more REs) from the allocated or selected RBs for one or more CG occasions. The excluded time-frequency resource(s) (for example, the excluded RE(s)) may be time-frequency resources that are associated with values of the channel estimation parameter that do not satisfy a threshold (for example, the UE 120 may exclude RE(s) that are associated with a capacity and/or SNR that is less than a given threshold). As another example, the UE 120 may exclude a given quantity of time-frequency resources (for example, a given quantity of REs) that are associated with the worst (for example, lowest) values for the channel estimation parameter(s). For example, the UE 120 may exclude S REs, where the S REs are associated with the worst (for example, lowest) values for the channel estimation parameter(s) among the allocated or selected REs for one or more CG occasions (for example, a value of S may be indicated via the configuration information in the second operation 510). By the UE 120 excluding the one or more time-frequency resources, the performance of CG communications or transmissions may be improved, because the UE 120 does not transmit the CG communications or transmissions using time-frequency resources having poor performance in the current channel conditions.

Additionally or alternatively, the UE 120 (for example, in the seventh operation 535) may select or determine one or more transmission parameters in accordance with the one or more channel estimation parameters and the one or more rules. The one or more transmission parameters may be for one or more upcoming CG occasions or one or more upcoming transmission occasions (for example, indicated by the CG configuration). The one or more transmission parameters may include an MCS, a rank, a code rate, a transport block size, a quantity of layers, a modulation order, a spectral efficiency, and/or one or more transmit power parameters (for example, a transmit power), among other examples. By selecting the one or more transmission parameters for one or more CG occasions based on, in response to, or otherwise associated with current channel conditions, the UE 120 may improve the network resource utilization and/or capacity of transmissions via the one or more CG occasions.

The UE 120 may select a value for a given transmission parameter from a set of candidate values for the transmission parameter (for example, where the set of candidate values for the transmission parameter are indicated via the CG configuration or other configuration information). In a similar manner as described elsewhere herein, the UE 120 may select the value for a transmission parameter based on, in accordance with, or otherwise associated with the one or more channel estimation parameters and/or the one or more rules. For example, the one or more rules may indicate that the UE 120 is to select a value for a given transmission parameter that results in a best (or highest) capacity, SNR, or other parameter based on, in accordance with, or otherwise associated with the one or more channel estimation parameters. For example, the UE 120 may select an MCS, a rank, or another transmission parameter that the UE 120 determines will result in a best or highest capacity, SNR, or other parameter (for example, based on the current channel conditions as indicated by the one or more channel estimation parameters).

In some aspects, the UE 120 may select or determine the one or more transmission parameters for a given time-frequency allocation or selection. In other words, the UE 120 may select or determine the one or more transmission parameters without modifying a time-frequency allocation or selection based on, in response to, or otherwise associated with the selected valuc(s) of the transmission parameter(s). For example, the UE 120 may select an MCS, a rank, or another transmission parameter without making any changes to the allocated or selected RBs for one or more CG occasions. This may increase the capacity and/or may increase the size of a payload of transmissions that are transmitted via the one or more CG occasions (for example, by optimizing the transmission parameter(s) for the one or more CG occasions in a given time-frequency resource allocation).

In some other aspects, the UE 120 may modify the allocated or selected time-frequency resources for one or more CG occasions based on, in response to, or otherwise associated with the selected value(s) of the transmission parameter(s). For example, the UE 120 may increase or decrease a quantity of time-frequency resources for one or more CG occasions based on, in response to, or otherwise associated with the selected value(s) of the transmission parameter(s). For example, the UE 120 may increase or decrease the quantity of the one or more time-frequency resources so as to maintain a quantity of information bits to be included in one or more communications that are transmitted in accordance with the determined or selected transmission parameter(s). This may improve the spectral efficiency and/or improve the network resource utilization for transmissions via the one or more CG occasions.

In some aspects, the UE 120 may select or modify a time domain periodicity for the CG configuration based on, in response to, or otherwise associated with the current channel conditions. For example, the UE 120 may increase or decrease the amount of time between configured CG occasions for the CG configuration. In some aspects, the UE 120 may increase the amount of time between configured CG occasions for the CG configuration based on, in response to, or otherwise associated with the one or more channel estimation parameters not satisfying one or more thresholds (for example, based on, in response to, or otherwise associated with the one or more channel estimation parameters indicating poor channel conditions). The UE 120 may decrease the amount of time between configured CG occasions for the CG configuration based on, in response to, or otherwise associated with the one or more channel estimation parameters satisfying one or more thresholds (for example, based on, in response to, or otherwise associated with the one or more channel estimation parameters indicating good channel conditions). Additionally or alternatively, the UE 120 may select or modify a time domain periodicity for the CG configuration based on, in response to, or otherwise associated with traffic pattern information associated with the UE 120. For example, the UE 120 may select or modify a time domain periodicity for the CG configuration based on, in response to, or otherwise associated with the traffic pattern information indicating that traffic (for example, to be transmitted via one or more CG occasions configured by the CG configuration) is arriving at the UE 120 more or less frequently (for example, as compared to a previous traffic pattern of the traffic).

In some aspects, the UE 120 may transmit, and the network node 110 may receive, an indication of the value(s) or information selected or determined by the UE 120 as part of the seventh operation 535. For example, the UE 120 may transmit control information (for example, UCI) and/or one or more MAC communications (for example, one or more MAC-CEs) indicating the value(s) or information selected or determined by the UE 120 as part of the seventh operation 535. In other examples, the UE 120 may not transmit the indication of the value(s) or information selected or determined by the UE 120 as part of the seventh operation 535. In such examples, the network node 110 may select and/or determine the value(s) or information, such as in an eighth operation 540.

For example, in the eighth operation 540, the network node 110 may select one or more values for one or more parameters of the CG configuration. For example, the network node 110 may select the one or more values for one or more parameters of the CG configuration based on, in response to, in accordance with, or otherwise associated with the one or more channel estimation parameters (for example, obtained via the fourth operation 520). The network node 110 may select the one or more values in accordance with the one or more channel estimation parameters and the one or more rules. The network node 110 may select or determine the values or information for the one or more parameters of the CG configuration (for example, for one or more CG occasions) in a similar manner as described in connection with the seventh operation 535. For example, the network node 110 may use similar techniques or methods for selecting or determining the values or information for the one or more parameters of the CG configuration as the UE 120.

As described elsewhere herein, the CG configuration may indicate a default configuration (for example, associated with one or more default values for respective parameters). The UE 120 and the network node 110 may use a modified CG configuration (for example, using one or more values for the respective parameters selected by the UE and/or the network node in accordance with the one or more rules and the one or more channel estimation parameters, such as in the seventh operation 535 and/or the eighth operation 540) based on, in response to, or otherwise associated with a performance metric of the modified CG configuration being greater than a performance metric of the default CG configuration by an amount that satisfies a threshold. The performance metric may be a capacity, an SNR, a spectral efficiency, or another performance metric. For example, the UE 120 and the network node may determine or select the modified CG configuration (for example, in the seventh operation 535 and the eighth operation 540, respectively). The UE 120 may compare a first performance metric (for example, a first value of a performance metric) of the modified CG configuration to a second performance metric (for example, a second value of a performance metric) of the default CG configuration based on, in response to, in accordance with, or otherwise associated with current channel conditions (for example, the one or more channel estimation parameters). If the first performance metric is greater than the second performance metric by a given value (for example, a threshold value), then the UE 120 and the network node 110 may use the modified CG configuration. Otherwise, the UE 120 and the network node 110 may use the default configuration. The given value (for example, the threshold value) may be indicated via the configuration information in the second operation 510. The given value may be a value of the performance metric (for example, E decibels if the performance metric is SNR). By only using the modified CG configuration if the first performance metric is greater than the second performance metric by the given value, the UE 120 and the network node 110 may decrease the likelihood of issues caused by mismatched channel estimation parameters at the UE 120 and the network node 110 (for example, because the modified CG configuration is only used if the modified CG configuration is better than the default CG configuration by a given amount, thereby reducing the likelihood that the channel estimation parameters used by the UE 120 and the network node 110 are meaningfully different).

Additionally or alternatively, the one or more channel estimation parameters used by the UE 120 and the network node 110 may be previously obtained or outdated (for example, may be from T time units (for example, slots, symbols, subframes, or another time unit) prior to a current slot, or may be from a previously communicated report from the UE 120). For example, as part of the sixth operation 530, the UE 120 may transmit, and the network node 110 may receive, the one or more channel estimation parameters. The UE 120 and the network node 110 may use the reported channel estimation parameter(s) when selecting or determining the values or information for the parameter(s) of the CG configuration (for example, in the seventh operation 535 and the eighth operation 540, respectively). As another example, the UE 120 and the network node 110 may use the channel estimation parameter(s) determined or obtained T time units (for example, slots, symbols, subframes, or another time unit) prior to a current time. By using “outdated” channel estimation parameters, the likelihood of the UE 120 and the network node 110 using mismatched or different channel estimation parameters to select or determine the values or information for the parameter(s) of the CG configuration may be reduced.

Additionally or alternatively, the UE 120 and the network node 110 may determine or select the values or information for the parameter(s) of the CG configuration (for example, in the seventh operation 535 and the eighth operation 540, respectively) based on, in response to, or otherwise associated with operating in a scenario in which channel information for a downlink channel is expected to be available at both the UE 120 and the network node 110. For example, the scenario may include low Doppler TDD scenarios, full-duplex scenarios, subband full-duplex scenarios, and/or other scenarios.

The UE 120 and the network node 110 may determine or select the values or information for the parameter(s) of the CG configuration (for example, in the seventh operation 535 and the eighth operation 540, respectively) at various times. For example, the UE 120 and the network node 110 may determine or select the values or information for the parameter(s) of the CG configuration (for example, in the seventh operation 535 and the eighth operation 540, respectively) periodically, such as in accordance with a time domain periodicity of the CG occasions configured via the CG configuration. For example, the UE 120 and the network node 110 may determine or select the values or information for the parameter(s) of the CG configuration (for example, in the seventh operation 535 and the eighth operation 540, respectively) prior to each time interval (for example, each slot, mini-slot, symbol, subframe, or other time unit) in which at least one CG occasion is configured. The UE 120 and the network node 110 may use the values or information determined prior to that time interval for the CG occasion(s) configured to occur during that time interval. In other examples, the UE 120 and the network node 110 may determine or select the values or information for the parameter(s) of the CG configuration (for example, in the seventh operation 535 and the eighth operation 540, respectively) in accordance with periodicities, such as every Z time intervals (for example, every Z slots, mini-slots, symbols, subframes, or other time units).

Additionally or alternatively, the UE 120 and the network node 110 may determine or select the values or information for the parameter(s) of the CG configuration (for example, in the seventh operation 535 and the eighth operation 540, respectively) based on, in response to, or otherwise associated with detecting an event. The event may include a change in one or more channel estimation parameters satisfying a threshold. As another example, the event may include an error rate or other metric associated with transmission(s) in accordance with the default configuration satisfying an error threshold.

In a ninth operation 545, the UE 120 may transmit one or more CG communications in accordance with the values or information for the parameter(s) of the CG configuration (for example, determined or selected by the UE 120 in the seventh operation 535). In some aspects, the network node 110 may receive the one or more CG communications in accordance with the values or information for the parameter(s) of the CG configuration (for example, determined or selected by the network node in the eighth operation 540). In other examples, the UE 120 may transmit one or more CG communications to another UE 120 (for example, if the CG configuration is a sidelink CG configuration). In other examples, the network node 110 may transmit, and the UE 120 may receive, one or more communications in accordance with the values or information for the parameter(s) selected or determined by the UE 120 and/or the UE 120 (for example, in downlink SPS configuration examples).

For example, in the ninth operation 545, the UE 120 may transmit one or more communications during a CG occasion configured by the configuration information in the second operation 510. The UE 120 may transmit the one or more communications using, in accordance with, or otherwise associated with the value(s) and/or information for one or more parameters as determined or selected by the UE 120 in the seventh operation 535. In another CG occasion (for example, occurring after the CG occasion during which the communication(s) are transmitted in the ninth operation 545), the UE 120 may transmit one or more other communications using value(s) and/or information for one or more parameters as determined or selected after the ninth operation 545.

For example, after the ninth operation 545, the UE 120 and the network node 110 may continue to evaluate channel conditions (for example, in a similar manner as described in connection with the fourth operation 520 and the sixth operation 530, respectively) and select parameter(s) for upcoming CG occasions in accordance with the evaluated channel conditions (for example, in a similar manner as described in connection with the seventh operation 535 and the eighth operation 540, respectively). The UE 120 and the network node 110 may continue to evaluate channel conditions and select value(s) or information for parameter(s) of the CG configuration in accordance with the evaluated channel conditions as described herein until the network node 110 indicates that the channel-aware or channel-based CG configuration is no longer to be used or applied (for example, via RRC signaling, MAC signaling, or other signaling).

FIG. 6 is a flowchart illustrating an example process 600 performed, for example, at a UE or an apparatus of a UE that supports a channel-condition-based configured grant configuration in accordance with the present disclosure. Example process 600 is an example where the apparatus or the UE (for example, UE 120) performs operations associated with a channel-condition-based configured grant configuration.

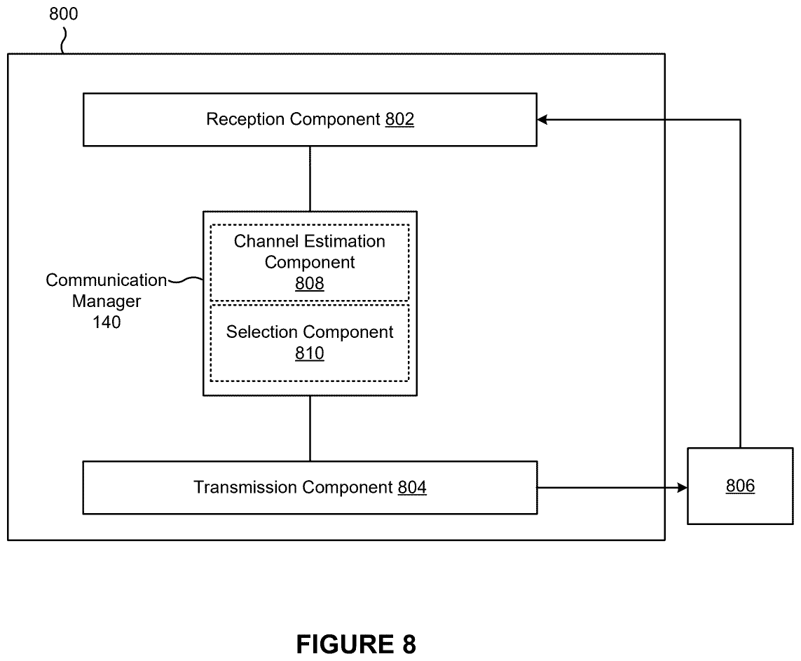

As shown in FIG. 6, in some aspects, process 600 may include receiving a configured grant configuration that includes a resource allocation, the resource allocation indicating one or more parameters that are associated with one or more selection rules (block 610). For example, the UE (such as by using communication manager 140 or reception component 802, depicted in FIG. 8) may receive a configured grant configuration that includes a resource allocation, the resource allocation indicating one or more parameters that are associated with one or more selection rules, as described above.

As further shown in FIG. 6, in some aspects, process 600 may include transmitting one or more communications in accordance with values of respective parameters of the one or more parameters, the values being in accordance with one or more channel estimation parameters and the one or more selection rules (block 620). For example, the UE (such as by using communication manager 140 or transmission component 804, depicted in FIG. 8) may transmit one or more communications in accordance with values of respective parameters of the one or more parameters, the values being in accordance with one or more channel estimation parameters and the one or more selection rules, as described above.

Process 600 may include additional aspects, such as any single aspect or any combination of aspects described below or in connection with one or more other processes described elsewhere herein.

In a first additional aspect, the one or more parameters include at least one of an indication of a set of one or more time-frequency resources, a time domain periodicity, or one or more transmission parameters.

In a second additional aspect, alone or in combination with the first aspect, the one or more transmission parameters include at least one of a modulation and coding scheme, or a rank.

In a third additional aspect, alone or in combination with one or more of the first and second aspects, the resource allocation indicates a set of values for a parameter of the one or more parameters, where the set of values are included in the values, and transmitting the one or more communications in accordance with the values includes transmitting the one or more communications in accordance with a subset of one or more values, from the set of values, for the parameter, in accordance with the one or more channel estimation parameters and the one or more selection rules.

In a fourth additional aspect, alone or in combination with one or more of the first through third aspects, the one or more channel estimation parameters include at least one of a signal-to-noise ratio, a channel capacity, or one or more channel estimation matrix parameters.

In a fifth additional aspect, alone or in combination with one or more of the first through fourth aspects, the one or more parameters indicate a set of candidate time-frequency resources, and transmitting the one or more communications includes transmitting the one or more communications via one or more time-frequency resources from the set of candidate time-frequency resources in accordance with the one or more selection rules and the one or more channel estimation parameters.

In a sixth additional aspect, alone or in combination with one or more of the first through fifth aspects, a quantity of the one or more time-frequency resources is indicated via the configured grant configuration.

In a seventh additional aspect, alone or in combination with one or more of the first through sixth aspects, the one or more time-frequency resources are associated with a best value for the one or more channel estimation parameters among the set of candidate time-frequency resources.

In an eighth additional aspect, alone or in combination with one or more of the first through seventh aspects, the one or more time-frequency resources are contiguous in a frequency domain or a time domain.

In a ninth additional aspect, alone or in combination with one or more of the first through eighth aspects, the one or more selection rules are associated with a channel estimation parameter, of the one or more channel estimation parameters, and a threshold, and the one or more time-frequency resources are selected in accordance with the channel estimation parameter, for the one or more time-frequency resources, satisfying the threshold.

In a tenth additional aspect, alone or in combination with one or more of the first through ninth aspects, the one or more selection rules are associated with a channel estimation parameter, of the one or more channel estimation parameters, and a threshold, and time-frequency resources, from the set of candidate time-frequency resources, that are associated with values of the channel estimation parameter that do not satisfy the threshold are excluded from the one or more time-frequency resources.

In an eleventh additional aspect, alone or in combination with one or more of the first through tenth aspects, the one or more parameters include one or more transmission parameters, and transmitting the one or more communications includes transmitting the one or more communications in accordance with one or more transmission parameter values and one or more time-frequency resources that are in accordance with the one or more channel estimation parameters and the one or more selection rules, where the one or more transmission parameter values are associated with respective transmission parameters of the one or more transmission parameters.

In a twelfth additional aspect, alone or in combination with one or more of the first through eleventh aspects, the one or more time-frequency resources are indicated by the resource allocation.

In a thirteenth additional aspect, alone or in combination with one or more of the first through twelfth aspects, a quantity of the one or more time-frequency resources is associated with the one or more transmission parameter values.

In a fourteenth additional aspect, alone or in combination with one or more of the first through thirteenth aspects, the quantity of the one or more time-frequency resources is associated with maintaining a quantity of information bits included in the one or more communications.

In a fifteenth additional aspect, alone or in combination with one or more of the first through fourteenth aspects, process 600 includes transmitting one or more uplink reference signals, where the one or more channel estimation parameters are associated with the one or more uplink reference signals.

In a sixteenth additional aspect, alone or in combination with one or more of the first through fifteenth aspects, process 600 includes receiving one or more downlink reference signals, where the one or more channel estimation parameters are associated with the one or more downlink reference signals.

In a seventeenth additional aspect, alone or in combination with one or more of the first through sixteenth aspects, the configured grant configuration indicates a default resource allocation, and the one or more selection rules indicate that the resource allocation is to be used instead of the default resource allocation in association with the one or more channel estimation parameters satisfying one or more thresholds.

In an eighteenth additional aspect, alone or in combination with one or more of the first through seventeenth aspects, transmitting the one or more communications includes transmitting the one or more communications during a first time interval, where the one or more channel estimation parameters are associated with a second time interval that occurred before the first time interval.

Although FIG. 6 shows example blocks of process 600, in some aspects, process 600 may include additional blocks, fewer blocks, different blocks, or differently arranged blocks than those depicted in FIG. 6. Additionally or alternatively, two or more of the blocks of process 600 may be performed in parallel.

FIG. 7 is a flowchart illustrating an example process 700 performed, for example, at a network node or an apparatus of a network node that supports a channel-condition-based configured grant configuration in accordance with the present disclosure. Example process 700 is an example where the apparatus or the network node (for example, network node 110) performs operations associated with a channel-condition-based configured grant configuration.

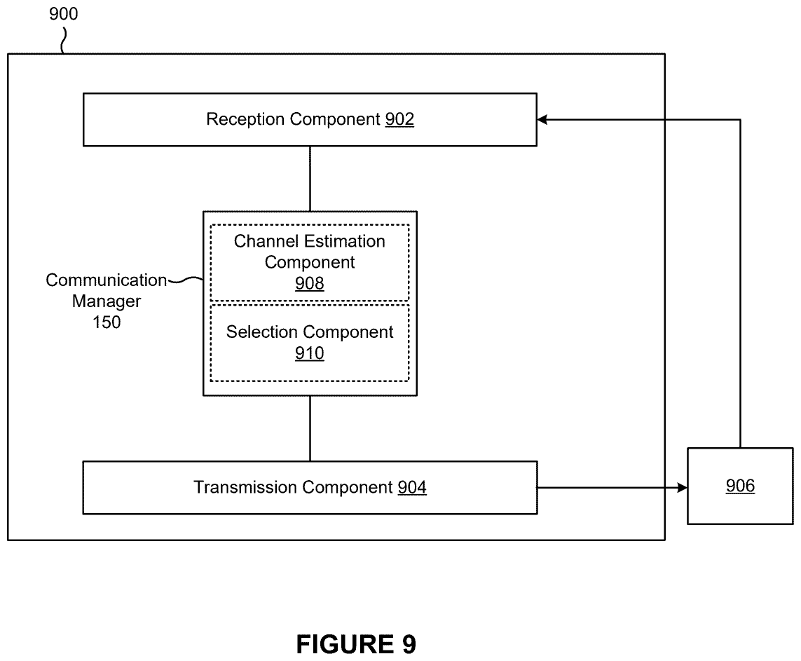

As shown in FIG. 7, in some aspects, process 700 may include transmitting a configured grant configuration that includes a resource allocation, the resource allocation indicating one or more parameters that are associated with one or more selection rules (block 710). For example, the network node (such as by using communication manager 150 or transmission component 904, depicted in FIG. 9) may transmit a configured grant configuration that includes a resource allocation, the resource allocation indicating one or more parameters that are associated with one or more selection rules, as described above.

As further shown in FIG. 7, in some aspects, process 700 may include receiving one or more communications in accordance with values of respective parameters of the one or more parameters, the values being in accordance with one or more channel estimation parameters and the one or more selection rules (block 720). For example, the network node (such as by using communication manager 150 or reception component 902, depicted in FIG. 9) may receive one or more communications in accordance with values of respective parameters of the one or more parameters, the values being in accordance with one or more channel estimation parameters and the one or more selection rules, as described above.

Process 700 may include additional aspects, such as any single aspect or any combination of aspects described below or in connection with one or more other processes described elsewhere herein.

In a first additional aspect, the one or more parameters include at least one of an indication of a set of one or more time-frequency resources, a time domain periodicity, or one or more transmission parameters.

In a second additional aspect, alone or in combination with the first aspect, the one or more transmission parameters include at least one of a modulation and coding scheme, or a rank.

In a third additional aspect, alone or in combination with one or more of the first and second aspects, the resource allocation indicates a set of values for a parameter of the one or more parameters, where the set of values are included in the values, and receiving the one or more communications in accordance with the values includes receiving the one or more communications in accordance with a subset of one or more values, from the set of values, for the parameter in accordance with the one or more channel estimation parameters and the one or more selection rules.

In a fourth additional aspect, alone or in combination with one or more of the first through third aspects, the one or more channel estimation parameters include at least one of a signal-to-noise ratio, a channel capacity, or one or more channel estimation matrix parameters.

In a fifth additional aspect, alone or in combination with one or more of the first through fourth aspects, the one or more parameters indicate a set of candidate time-frequency resources, and receiving the one or more communications includes receiving the one or more communications via one or more time-frequency resources from the set of candidate time-frequency resources in accordance with the one or more selection rules and the one or more channel estimation parameters.

In a sixth additional aspect, alone or in combination with one or more of the first through fifth aspects, a quantity of the one or more time-frequency resources is indicated via the configured grant configuration.

In a seventh additional aspect, alone or in combination with one or more of the first through sixth aspects, the one or more time-frequency resources are associated with a best value for the one or more channel estimation parameters among the set of candidate time-frequency resources.

In an eighth additional aspect, alone or in combination with one or more of the first through seventh aspects, the one or more time-frequency resources are contiguous in a frequency domain.

In a ninth additional aspect, alone or in combination with one or more of the first through eighth aspects, the one or more selection rules are associated with a channel estimation parameter, of the one or more channel estimation parameters, and a threshold, and the one or more time-frequency resources are selected in accordance with the channel estimation parameter, for the one or more time-frequency resources, satisfying the threshold.

In a tenth additional aspect, alone or in combination with one or more of the first through ninth aspects, the one or more selection rules are associated with a channel estimation parameter, of the one or more channel estimation parameters, and a threshold, and time-frequency resources, from the set of candidate time-frequency resources, that are associated with values of the channel estimation parameter that do not satisfy the threshold are excluded from the one or more time-frequency resources.

In an eleventh additional aspect, alone or in combination with one or more of the first through tenth aspects, the one or more parameters include one or more transmission parameters, and receiving the one or more communications includes receiving the one or more communications in accordance with one or more transmission parameter values and one or more time-frequency resources that are in accordance with the one or more channel estimation parameters and the one or more selection rules, where the one or more transmission parameter values are associated with respective transmission parameters of the one or more transmission parameters.

In a twelfth additional aspect, alone or in combination with one or more of the first through eleventh aspects, the one or more time-frequency resources are indicated by the resource allocation.

In a thirteenth additional aspect, alone or in combination with one or more of the first through twelfth aspects, a quantity of the one or more time-frequency resources is associated with the one or more transmission parameter values.

In a fourteenth additional aspect, alone or in combination with one or more of the first through thirteenth aspects, the quantity of the one or more time-frequency resources is associated with maintaining a quantity of information bits included in the one or more communications.

In a fifteenth additional aspect, alone or in combination with one or more of the first through fourteenth aspects, process 700 includes receiving one or more uplink reference signals, where the one or more channel estimation parameters are associated with the one or more uplink reference signals.

In a sixteenth additional aspect, alone or in combination with one or more of the first through fifteenth aspects, process 700 includes transmitting one or more downlink reference signals, where the one or more channel estimation parameters are associated with the one or more downlink reference signals.

In a seventeenth additional aspect, alone or in combination with one or more of the first through sixteenth aspects, the configured grant configuration indicates a default resource allocation, and the one or more selection rules indicate that the resource allocation is to be used instead of the default resource allocation in association with the one or more channel estimation parameters satisfying one or more thresholds.

In an eighteenth additional aspect, alone or in combination with one or more of the first through seventeenth aspects, receiving the one or more communications includes receiving the one or more communications during a first time interval, where the one or more channel estimation parameters are associated with a second time interval that occurred before the first time interval.

Although FIG. 7 shows example blocks of process 700, in some aspects, process 700 may include additional blocks, fewer blocks, different blocks, or differently arranged blocks than those depicted in FIG. 7. Additionally or alternatively, two or more of the blocks of process 700 may be performed in parallel.

FIG. 8 is a diagram of an example apparatus 800 for wireless communication that supports a channel-condition-based configured grant configuration in accordance with the present disclosure. The apparatus 800 may be a UE, or a UE may include the apparatus 800. In some aspects, the apparatus 800 includes a reception component 802, a transmission component 804, and a communication manager 140, which may be in communication with one another (for example, via one or more buses). As shown, the apparatus 800 may communicate with another apparatus 806 (such as a UE, a network node, or another wireless communication device) using the reception component 802 and the transmission component 804.

In some aspects, the apparatus 800 may be configured to and/or operable to perform one or more operations described herein in connection with FIG. 5.

Additionally or alternatively, the apparatus 800 may be configured to and/or operable to perform one or more processes described herein, such as process 600 of FIG. 6. In some aspects, the apparatus 800 may include one or more components of the UE described above in connection with FIG. 1 and FIG. 2.

The reception component 802 may receive communications, such as reference signals, control information, and/or data communications, from the apparatus 806. The reception component 802 may provide received communications to one or more other components of the apparatus 800, such as the communication manager 140. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 802 may include one or more antennas, one or more modems, one or more demodulators, one or more MIMO detectors, one or more receive processors, one or more controllers/processors, and/or one or more memories of the UE described above in connection with FIG. 1 and FIG. 2.

The transmission component 804 may transmit communications, such as

reference signals, control information, and/or data communications, to the apparatus 806. In some aspects, the communication manager 140 may generate communications and may transmit the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, one or more modems, one or more modulators, one or more transmit MIMO processors, one or more transmit processors, one or more controllers/processors, and/or one or more memories of the UE described above in connection with FIG. 1 and FIG. 2. In some aspects, the transmission component 804 may be co-located with the reception component 802 in one or more transceivers.

The communication manager 140 may receive or may cause the reception component 802 to receive a configured grant configuration that includes a resource allocation, the resource allocation indicating one or more parameters that are associated with one or more selection rules. The communication manager 140 may transmit or may cause the transmission component 804 to transmit one or more communications in accordance with values of respective parameters of the one or more parameters, the values being in accordance with one or more channel estimation parameters and the one or more selection rules. In some aspects, the communication manager 140 may perform one or more operations described elsewhere herein as being performed by one or more components of the communication manager 140.

The communication manager 140 may include one or more controllers/processors, one or more memories, of the UE described above in connection with FIG. 1 and FIG. 2. In some aspects, the communication manager 140 includes a set of components, such as a channel estimation component 808, and/or a selection component 810. Alternatively, the set of components may be separate and distinct from the communication manager 140. In some aspects, one or more components of the set of components may include or may be implemented within one or more controllers/processors, one or more memories, of the UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive a configured grant configuration that includes a resource allocation, the resource allocation indicating one or more parameters that are associated with one or more selection rules. The transmission component 804 may transmit one or more communications in accordance with values of respective parameters of the one or more parameters, the values being in accordance with one or more channel estimation parameters and the one or more selection rules.

The channel estimation component 808 may obtain the one or more channel estimation parameters (for example, via one or more measurements of one or more reference signals). The selection component 810 may select the values of respective parameters of the one or more parameters in accordance with one or more channel estimation parameters and the one or more selection rules.

The transmission component 804 may transmit one or more uplink reference signals, wherein the one or more channel estimation parameters are associated with the one or more uplink reference signals.

The reception component 802 may receive one or more downlink reference signals, wherein the one or more channel estimation parameters are associated with the one or more downlink reference signals.

The quantity and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally or alternatively, a set of (one or more) components shown in FIG. 8 may perform one or more functions described as being performed by another set of components shown in FIG. 8.

FIG. 9 is a diagram of an example apparatus 900 for wireless communication that supports a channel-condition-based configured grant configuration in accordance with the present disclosure. The apparatus 900 may be a network node, or a network node may include the apparatus 900. In some aspects, the apparatus 900 includes a reception component 902, a transmission component 904, and a communication manager 150, which may be in communication with one another (for example, via one or more buses). As shown, the apparatus 900 may communicate with another apparatus 906 (such as a UE, a network node, or another wireless communication device) using the reception component 902 and the transmission component 904.

In some aspects, the apparatus 900 may be configured to and/or operable to perform one or more operations described herein in connection with FIG. 5. Additionally or alternatively, the apparatus 900 may be configured to and/or operable to perform one or more processes described herein, such as process 700 of FIG. 7. In some aspects, the apparatus 900 may include one or more components of the network node described above in connection with FIG. 1 and FIG. 2.

The reception component 902 may receive communications, such as reference signals, control information, and/or data communications, from the apparatus 906. The reception component 902 may provide received communications to one or more other components of the apparatus 900, such as the communication manager 150. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 902 may include one or more antennas, one or more modems, one or more demodulators, one or more MIMO detectors, one or more receive processors, one or more controllers/processors, and/or one or more memories of the network node described above in connection with FIG. 1 and FIG. 2.

The transmission component 904 may transmit communications, such as reference signals, control information, and/or data communications, to the apparatus 906. In some aspects, the communication manager 150 may generate communications and may transmit the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, one or more modems, one or more modulators, one or more transmit MIMO processors, one or more transmit processors, one or more controllers/processors, and/or one or more memories of the network node described above in connection with FIG. 1 and FIG. 2. In some aspects, the transmission component 904 may be co-located with the reception component 902 in one or more transceivers.

The communication manager 150 may transmit or may cause the transmission component 904 to transmit a configured grant configuration that includes a resource allocation, the resource allocation indicating one or more parameters that are associated with one or more selection rules. The communication manager 150 may receive or may cause the reception component 902 to receive one or more communications in accordance with values of respective parameters of the one or more parameters, the values being in accordance with one or more channel estimation parameters and the one or more selection rules. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 1 and FIG. 2. In some aspects, the communication manager 150 includes a set of components, such as a channel estimation component 908, and/or a selection component 910. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 904 may transmit a configured grant configuration that includes a resource allocation, the resource allocation indicating one or more parameters that are associated with one or more selection rules. The reception component 902 may receive one or more communications in accordance with values of respective parameters of the one or more parameters, the values being in accordance with one or more channel estimation parameters and the one or more selection rules.

The channel estimation component 908 may obtain the one or more channel estimation parameters (for example, via one or more measurements of one or more reference signals). The selection component 910 may select the values of respective parameters of the one or more parameters in accordance with one or more channel estimation parameters and the one or more selection rules.

The reception component 902 may receive one or more uplink reference signals, wherein the one or more channel estimation parameters are associated with the one or more uplink reference signals.

The transmission component 904 may transmit one or more downlink reference signals, wherein the one or more channel estimation parameters are associated with the one or more downlink reference signals.

The quantity and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication by a user equipment (UE), comprising: receiving a configured grant configuration that includes a resource allocation, the resource allocation indicating one or more parameters that are associated with one or more selection rules; and transmitting one or more communications in accordance with values of respective parameters of the one or more parameters, the values being in accordance with one or more channel estimation parameters and the one or more selection rules.

Aspect 2: The method of Aspect 1, wherein the one or more parameters include at least one of: an indication of a set of one or more time-frequency resources, a time domain periodicity, or one or more transmission parameters.

Aspect 3: The method of Aspect 2, wherein the one or more transmission parameters include at least one of: a modulation and coding scheme, or a rank.

Aspect 4: The method of any of Aspects 1-3, wherein the resource allocation indicates a set of values for a parameter of the one or more parameters, wherein the set of values are included in the values, and wherein transmitting the one or more communications in accordance with the values comprises: transmitting the one or more communications in accordance with a subset of one or more values, from the set of values, for the parameter, in accordance with the one or more channel estimation parameters and the one or more selection rules.

Aspect 5: The method of any of Aspects 1-4, wherein the one or more channel estimation parameters include at least one of: a signal-to-noise ratio, a channel capacity, or one or more channel estimation matrix parameters.

Aspect 6: The method of any of Aspects 1-5, wherein the one or more parameters indicate a set of candidate time-frequency resources, and wherein transmitting the one or more communications comprises: transmitting the one or more communications via one or more time-frequency resources from the set of candidate time-frequency resources in accordance with the one or more selection rules and the one or more channel estimation parameters.

Aspect 7: The method of Aspect 6, wherein a quantity of the one or more time-frequency resources is indicated via the configured grant configuration.

Aspect 8: The method of any of Aspects 6-7, wherein the one or more time-frequency resources are associated with a best value for the one or more channel estimation parameters among the set of candidate time-frequency resources.

Aspect 9: The method of any of Aspects 6-8, wherein the one or more time-frequency resources are contiguous in a frequency domain or a time domain.

Aspect 10: The method of any of Aspects 6-9, wherein the one or more selection rules are associated with a channel estimation parameter, of the one or more channel estimation parameters, and a threshold, and wherein the one or more time-frequency resources are selected in accordance with the channel estimation parameter, for the one or more time-frequency resources, satisfying the threshold.

Aspect 11: The method of any of Aspects 6-10, wherein the one or more selection rules are associated with a channel estimation parameter, of the one or more channel estimation parameters, and a threshold, and wherein time-frequency resources, from the set of candidate time-frequency resources, that are associated with values of the channel estimation parameter that do not satisfy the threshold are excluded from the one or more time-frequency resources.

Aspect 12: The method of any of Aspects 1-11, wherein the one or more parameters include one or more transmission parameters, and wherein transmitting the one or more communications comprises: transmitting the one or more communications in accordance with one or more transmission parameter values and one or more time- frequency resources that are in accordance with the one or more channel estimation parameters and the one or more selection rules, wherein the one or more transmission parameter values are associated with respective transmission parameters of the one or more transmission parameters.

Aspect 13: The method of Aspect 12, wherein the one or more time-frequency resources are indicated by the resource allocation.

Aspect 14: The method of any of Aspects 12-13, wherein a quantity of the one or more time-frequency resources is associated with the one or more transmission parameter values.

Aspect 15: The method of Aspect 14, wherein the quantity of the one or more time-frequency resources is associated with maintaining a quantity of information bits included in the one or more communications.

Aspect 16: The method of any of Aspects 1-15, further comprising: transmitting one or more uplink reference signals, wherein the one or more channel estimation parameters are associated with the one or more uplink reference signals.

Aspect 17: The method of any of Aspects 1-16, further comprising: receiving one or more downlink reference signals, wherein the one or more channel estimation parameters are associated with the one or more downlink reference signals.

Aspect 18: The method of any of Aspects 1-17, wherein the configured grant configuration indicates a default resource allocation, and wherein the one or more selection rules indicate that the resource allocation is to be used instead of the default resource allocation in association with the one or more channel estimation parameters satisfying one or more thresholds.

Aspect 19: The method of any of Aspects 1-18, wherein transmitting the one or more communications comprises: transmitting the one or more communications during a first time interval, wherein the one or more channel estimation parameters are associated with a second time interval that occurred before the first time interval.

Aspect 20: A method of wireless communication by a network node, comprising: transmitting a configured grant configuration that includes a resource allocation, the resource allocation indicating one or more parameters that are associated with one or more selection rules; and receiving one or more communications in accordance with values of respective parameters of the one or more parameters, the values being in accordance with one or more channel estimation parameters and the one or more selection rules.

Aspect 21: The method of Aspect 20, wherein the one or more parameters include at least one of: an indication of a set of one or more time-frequency resources, a time domain periodicity, or one or more transmission parameters.

Aspect 22: The method of Aspect 21, wherein the one or more transmission parameters include at least one of: a modulation and coding scheme, or a rank.

Aspect 23: The method of any of Aspects 20-22, wherein the resource allocation indicates a set of values for a parameter of the one or more parameters, wherein the set of values are included in the values, wherein receiving the one or more communications in accordance with the values comprises: receiving the one or more communications in accordance with a subset of one or more values, from the set of values, for the parameter in accordance with the one or more channel estimation parameters and the one or more selection rules.

Aspect 24: The method of any of Aspects 20-23, wherein the one or more channel estimation parameters include at least one of: a signal-to-noise ratio, a channel capacity, or one or more channel estimation matrix parameters.

Aspect 25: The method of any of Aspects 20-24, wherein the one or more parameters indicate a set of candidate time-frequency resources, and wherein receiving the one or more communications comprises: receiving the one or more communications via one or more time-frequency resources from the set of candidate time-frequency resources in accordance with the one or more selection rules and the one or more channel estimation parameters.

Aspect 26: The method of Aspect 25, wherein a quantity of the one or more time-frequency resources is indicated via the configured grant configuration.

Aspect 27: The method of any of Aspects 25-26, wherein the one or more time-frequency resources are associated with a best value for the one or more channel estimation parameters among the set of candidate time-frequency resources.

Aspect 28: The method of any of Aspects 25-27, wherein the one or more time-frequency resources are contiguous in a frequency domain.

Aspect 29: The method of any of Aspects 25-28, wherein the one or more selection rules are associated with a channel estimation parameter, of the one or more channel estimation parameters, and a threshold, and wherein the one or more time-frequency resources are selected in accordance with the channel estimation parameter, for the one or more time-frequency resources, satisfying the threshold.

Aspect 30: The method of any of Aspects 25-29, wherein the one or more selection rules are associated with a channel estimation parameter, of the one or more channel estimation parameters, and a threshold, and wherein time-frequency resources, from the set of candidate time-frequency resources, that are associated with values of the channel estimation parameter that do not satisfy the threshold are excluded from the one or more time-frequency resources.

Aspect 31: The method of any of Aspects 20-30, wherein the one or more parameters include one or more transmission parameters, and wherein receiving the one or more communications comprises: receiving the one or more communications in accordance with one or more transmission parameter values and one or more time-frequency resources that are in accordance with the one or more channel estimation parameters and the one or more selection rules, wherein the one or more transmission parameter values are associated with respective transmission parameters of the one or more transmission parameters.

Aspect 32: The method of Aspect 31, wherein the one or more time-frequency resources are indicated by the resource allocation.

Aspect 33: The method of Aspect 32, wherein a quantity of the one or more time-frequency resources is associated with the one or more transmission parameter values.

Aspect 34: The method of Aspect 33, wherein the quantity of the one or more time-frequency resources is associated with maintaining a quantity of information bits included in the one or more communications.

Aspect 35: The method of any of Aspects 20-34, further comprising: receiving one or more uplink reference signals, wherein the one or more channel estimation parameters are associated with the one or more uplink reference signals.

Aspect 36: The method of any of Aspects 20-35, further comprising: transmitting one or more downlink reference signals, wherein the one or more channel estimation parameters are associated with the one or more downlink reference signals.

Aspect 37: The method of any of Aspects 20-36, wherein the configured grant configuration indicates a default resource allocation, and wherein the one or more selection rules indicate that the resource allocation is to be used instead of the default resource allocation in association with the one or more channel estimation parameters satisfying one or more thresholds.

Aspect 38: The method of any of Aspects 20-37, wherein receiving the one or more communications comprises: receiving the one or more communications during a first time interval, wherein the one or more channel estimation parameters are associated with a second time interval that occurred before the first time interval.

Aspect 39: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-38.

Aspect 40: An apparatus for wireless communication at a device, the apparatus comprising one or more memories and one or more processors coupled to the one or more memories, the one or more processors configured to cause the device to perform the method of one or more of Aspects 1-38.

Aspect 41: An apparatus for wireless communication, the apparatus comprising at least one means for performing the method of one or more of Aspects 1-38.

Aspect 42: A non-transitory computer-readable medium storing code for wireless communication, the code comprising instructions executable by one or more processors to perform the method of one or more of Aspects 1-38.

Aspect 43: A non-transitory computer-readable medium storing a set of instructions for wireless communication, the set of instructions comprising one or more instructions that, when executed by one or more processors of a device, cause the device to perform the method of one or more of Aspects 1-38.

Aspect 44: A device for wireless communication, the device comprising a processing system that includes one or more processors and one or more memories coupled with the one or more processors, the processing system configured to cause the device to perform the method of one or more of Aspects 1-38.

Aspect 45: An apparatus for wireless communication at a device, the apparatus comprising one or more memories and one or more processors coupled to the one or more memories, the one or more processors individually or collectively configured to cause the device to perform the method of one or more of Aspects 1-38.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
a processing system that includes one or more processors and one or more memories coupled with the one or more processors, the processing system configured to cause the UE to:
receive a configured grant configuration that includes a resource allocation, the resource allocation indicating one or more parameters that are associated with one or more selection rules; and
transmit one or more communications in accordance with values of respective parameters of the one or more parameters, the values being in accordance with one or more channel estimation parameters and the one or more selection rules.

2. The UE of claim 1, wherein the one or more parameters include at least one of:
an indication of a set of one or more time-frequency resources,
a time domain periodicity, or
one or more transmission parameters.

3. The UE of claim 1, wherein the resource allocation indicates a set of values for a parameter of the one or more parameters, wherein the set of values are included in the values, and wherein transmitting the one or more communications in accordance with the values comprises:
transmit the one or more communications in accordance with a subset of one or more values, from the set of values, for the parameter, in accordance with the one or more channel estimation parameters and the one or more selection rules.

4. The UE of claim 1, wherein the one or more parameters indicate a set of candidate time-frequency resources, and wherein transmitting the one or more communications comprises:
transmit the one or more communications via one or more time-frequency resources from the set of candidate time-frequency resources in accordance with the one or more selection rules and the one or more channel estimation parameters.

5. The UE of claim 4, wherein the one or more selection rules are associated with a channel estimation parameter, of the one or more channel estimation parameters, and a threshold, and wherein the one or more time-frequency resources are selected in accordance with the channel estimation parameter, for the one or more time-frequency resources, satisfying the threshold.

6. The UE of claim 4, wherein the one or more selection rules are associated with a channel estimation parameter, of the one or more channel estimation parameters, and a threshold, and wherein time-frequency resources, from the set of candidate time-frequency resources, that are associated with values of the channel estimation parameter that do not satisfy the threshold are excluded from the one or more time-frequency resources.

7. The UE of claim 1, wherein the one or more parameters include one or more transmission parameters, and wherein transmitting the one or more communications comprises:
transmit the one or more communications in accordance with one or more transmission parameter values and one or more time-frequency resources that are in accordance with the one or more channel estimation parameters and the one or more selection rules, wherein the one or more transmission parameter values are associated with respective transmission parameters of the one or more transmission parameters.

8. The UE of claim 7, wherein a quantity of the one or more time-frequency resources is associated with the one or more transmission parameter values.

9. The UE of claim 1, wherein the configured grant configuration indicates a default resource allocation, and wherein the one or more selection rules indicate that the resource allocation is to be used instead of the default resource allocation in association with the one or more channel estimation parameters satisfying one or more thresholds.

10. The UE of claim 1, wherein, to cause the UE to transmit the one or more communications, the processing system is configured to cause the UE to: transmit the one or more communications during a first time interval, wherein the one or more channel estimation parameters are associated with a second time interval that occurred before the first time interval.

11. A network node for wireless communication, comprising:
a processing system that includes one or more processors and one or more memories coupled with the one or more processors, the processing system configured to cause the network node to:
transmit a configured grant configuration that includes a resource allocation, the resource allocation indicating one or more parameters that are associated with one or more selection rules; and
receive one or more communications in accordance with values of respective parameters of the one or more parameters, the values being in accordance with one or more channel estimation parameters and the one or more selection rules.

12. The network node of claim 11, wherein the one or more parameters include at least one of:
an indication of a set of one or more time-frequency resources,
a time domain periodicity,
a modulation and coding scheme, or
a rank.

13. The network node of claim 11, wherein the resource allocation indicates a set of values for a parameter of the one or more parameters, wherein the set of values are included in the values, wherein receiving the one or more communications in accordance with the values comprises:
receive the one or more communications in accordance with a subset of one or more values, from the set of values, for the parameter in accordance with the one or more channel estimation parameters and the one or more selection rules.

14. The network node of claim 11, wherein the one or more parameters indicate a set of candidate time-frequency resources, and wherein receiving the one or more communications comprises:
receive the one or more communications via one or more time-frequency resources from the set of candidate time-frequency resources in accordance with the one or more selection rules and the one or more channel estimation parameters.

15. The network node of claim 14, wherein the one or more time-frequency resources are associated with a best value for the one or more channel estimation parameters among the set of candidate time-frequency resources.

16. The network node of claim 14, wherein the one or more time-frequency resources are contiguous in a frequency domain.

17. The network node of claim 11, wherein the one or more parameters include one or more transmission parameters, and wherein receiving the one or more communications comprises:
receive the one or more communications in accordance with one or more transmission parameter values and one or more time-frequency resources that are in accordance with the one or more channel estimation parameters and the one or more selection rules, wherein the one or more transmission parameter values are associated with respective transmission parameters of the one or more transmission parameters.

18. The network node of claim 17, wherein a quantity of the one or more time-frequency resources is associated with the one or more transmission parameter values.

19. The network node of claim 18, wherein the quantity of the one or more time-frequency resources is associated with maintaining a quantity of information bits included in the one or more communications.

20. The network node of claim 11, wherein the configured grant configuration indicates a default resource allocation, and wherein the one or more selection rules indicate that the resource allocation is to be used instead of the default resource allocation in association with the one or more channel estimation parameters satisfying one or more thresholds.

21. The network node of claim 11, wherein, to cause the network node to receive the one or more communications, the processing system is configured to cause the network node to:
receive the one or more communications during a first time interval, wherein the one or more channel estimation parameters are associated with a second time interval that occurred before the first time interval.

22. A method of wireless communication by a user equipment (UE), comprising:
receiving a configured grant configuration that includes a resource allocation, the resource allocation indicating one or more parameters that are associated with one or more selection rules; and
transmitting one or more communications in accordance with values of respective parameters of the one or more parameters, the values being in accordance with one or more channel estimation parameters and the one or more selection rules.

23. The method of claim 22, wherein the resource allocation indicates a set of values for a parameter of the one or more parameters, wherein the set of values are included in the values, and wherein transmitting the one or more communications in accordance with the values comprises:
transmitting the one or more communications in accordance with a subset of one or more values, from the set of values, for the parameter, in accordance with the one or more channel estimation parameters and the one or more selection rules.

24. The method of claim 22, wherein the one or more parameters indicate a set of candidate time-frequency resources, and wherein transmitting the one or more communications comprises:
transmitting the one or more communications via one or more time-frequency resources from the set of candidate time-frequency resources in accordance with the one or more selection rules and the one or more channel estimation parameters.

25. The method of claim 22, wherein the one or more parameters include one or more transmission parameters, and wherein transmitting the one or more communications comprises: transmitting the one or more communications in accordance with one or more transmission parameter values and one or more time-frequency resources that are in accordance with the one or more channel estimation parameters and the one or more selection rules, wherein the one or more transmission parameter values are associated with respective transmission parameters of the one or more transmission parameters.

26. The method of claim 22, wherein the configured grant configuration indicates a default resource allocation, and wherein the one or more selection rules indicate that the resource allocation is to be used instead of the default resource allocation in association with the one or more channel estimation parameters satisfying one or more thresholds.

27. The method of claim 22, wherein transmitting the one or more communications comprises:
transmitting the one or more communications during a first time interval, wherein the one or more channel estimation parameters are associated with a second time interval that occurred before the first time interval.

28. A method of wireless communication by a network node, comprising:
transmitting a configured grant configuration that includes a resource allocation, the resource allocation indicating one or more parameters that are associated with one or more selection rules; and
receiving one or more communications in accordance with values of respective parameters of the one or more parameters, the values being in accordance with one or more channel estimation parameters and the one or more selection rules.

29. The method of claim 28, wherein the resource allocation indicates a set of values for a parameter of the one or more parameters, wherein the set of values are included in the values, wherein receiving the one or more communications in accordance with the values comprises:
receiving the one or more communications in accordance with a subset of one or more values, from the set of values, for the parameter in accordance with the one or more channel estimation parameters and the one or more selection rules.

30. The method of claim 28, wherein the one or more parameters indicate a set of candidate time-frequency resources, and wherein receiving the one or more communications comprises:
receiving the one or more communications via one or more time-frequency resources from the set of candidate time-frequency resources in accordance with the one or more selection rules and the one or more channel estimation parameters.
